(19) United States
(12) Patent Application Publication
(10) Pub. No.: US 2024/0201957 A1
(43) Pub. Date: Jun. 20, 2024

(54) NEURAL NETWORK MODEL DEFINITION CODE GENERATION AND OPTIMIZATION

(71) Applicant: Micron Technology, Inc., Boise, ID (US)

(72) Inventors: Abhishek Chaurasia, Redmond, WA (US); Andre Xian Ming Chang, Bellevue, WA (US)

(21) Appl. No.: 18/513,232

(22) Filed: Nov. 17, 2023

Related U.S. Application Data
(60) Provisional application No. 63/476,053, filed on Dec. 19, 2022.

(51) Int. Cl. G06F 8/34; G06F 8/36

(52) U.S. Cl. CPC G06F 8/34; G06F 8/36

(57) ABSTRACT

A system providing neural network model definition code generation and optimization is disclosed. The system receives inputs to facilitate the generation of an artificial intelligence model, such as freehand drawings of a model, modules available in repositories, various forms of content, and other inputs. The system utilizes a neural network to analyze the inputs and generates blocks and connections to generate a graph for the artificial intelligence model. Properties of the model are selected, and the system locates modules, generates code for modules, or both, based on the blocks and connections from the graph and the properties. The system generates the model definition for the artificial intelligence model using the located modules and the generated code. Once the model definition is completed, the artificial intelligence model may be utilized to perform a task for which the artificial intelligence model has been created to perform.

### RELATED APPLICATIONS

The present application claims priority to Prov. U.S. Pat. App. Ser. No. 63/476,053 filed Dec. 19, 2022, the entire disclosure of which application is hereby incorporated herein by reference.

### FIELD OF THE TECHNOLOGY

At least some embodiments disclosed herein relate to neural networks, neural architecture search, neural network model generation technologies, neural network model optimization technologies, code generation technologies, and more particularly, but not limited to, a system for providing neural network model definition code generation and optimization.

### BACKGROUND

Creating an artificial intelligence model often requires significant amounts of mental effort, sketching, software development, and testing. For example, a developer or data scientist may prepare a hand sketch or drawing of the graph corresponding to the artificial intelligence model. Such a graph may include drawing various blocks including descriptive text and lines illustrating how the blocks are connected to each other within the artificial intelligence model. An artificial intelligence model may include a plurality of blocks or layers to support the functionality that the artificial intelligence model is designed to perform. For example, the artificial intelligence model may include an input layer, an output layer, and any number of hidden layers in between the input layers and output layers. The input layer may accept input data and pass the input data to the rest of the neural network in which the artificial intelligence model resides. For example, the input layer may pass the input data to a hidden layer, which may then utilize artificial intelligence algorithms supporting the functionality of the hidden layer to transform the data, facilitate automatic feature creation, among other artificial intelligence functions. Once the data is processed by the hidden layer(s), the data may then be passed from the hidden layer(s) to the output layer, which may output the result of the processing.

Once the drawing of the graph is completed, a developer or data scientist may proceed with writing the code that implements the blocks and connections of the graph. The developer may then test the generated code against any number of datasets to determine whether the artificial intelligence model works as expected or if adjustments need to be made. Even if the model works as expected, as the datasets, requirements, and tasks change over time, it is desirable to be able to modify and optimize the artificial intelligence model so that the models utilize fewer computer resources, while also accurately performing the required task. The field of neural architecture search has the aim of discovering and identifying models for performing a particular task. Nevertheless, technologies and techniques for developing and enhancing artificial intelligence models may be enhanced to provide greater accuracy, while also utilizing fewer computer resources.

### BRIEF DESCRIPTION OF THE DRAWINGS

The embodiments are illustrated by way of example and not limitation in the figures of the accompanying drawings in which like references indicate similar elements.

FIG. 1 illustrates an exemplary system for providing neural network model definition code generation and optimization according to embodiments of the present disclosure.

FIG. 2 illustrates an exemplary integrated circuit device including a deep learning accelerator and memory for use with the system of FIG. 1 according to embodiments of the present disclosure.

FIG. 3 illustrates an exemplary deep learning accelerator and memory configured to operate with an artificial neural network for use with the system of FIG. 1 according to embodiments of the present disclosure.

FIG. 4 illustrates an exemplary architecture for generating an artificial intelligence model according to embodiments of the present disclosure.

FIG. 5 illustrates an exemplary user interface enabling creation of pre-defined or custom-built modules for an artificial intelligence model according to embodiments of the present disclosure.

FIG. 6 illustrates an exemplary user interface enabling creation of artificial intelligence models from freehand-generated images according to embodiments of the present disclosure.

FIG. 7 illustrates an exemplary user interface enabling optimization of an artificial intelligence model using neural architecture search according to embodiments of the present disclosure.

FIG. 8 illustrates an exemplary intermediate neural architecture search for locating alternate blocks for a user model to provide an optimized version of the model according to embodiments of the present disclosure.

FIG. 9 illustrates an exemplary search space, an original user model for use with an artificial neural network, and selection of an insertion point for substituting an existing module according to embodiments of the present disclosure.

FIG. 10 illustrates application of a metric rank to candidate modules from a search space to facilitate generation of a ranking of candidate modules for substituting an existing module of a model according to embodiments of the present disclosure.

FIG. 11 illustrates utilizing intermediate module distillation applied to candidate modules of candidate models to determine accuracy ranks for each of the candidate modules according to embodiments of the present disclosure.

FIG. 12 illustrates executing candidate models including the candidate modules on a deep learning accelerator to determine runtime execution ranks for each of the candidate models according to embodiments of the present disclosure.

FIG. 13 illustrates an exemplary user interface enabling generation of an artificial intelligence model providing further customization capabilities and utilizing intermediate neural architecture search according to embodiments of the present disclosure.

FIG. 14 shows an exemplary method for providing neural network model definition code generation and optimization in accordance with embodiments of the present disclosure.

FIG. 15 illustrates a schematic diagram of a machine in the form of a computer system within which a set of instructions, when executed, may cause the machine to facilitate neural network model definition code generation and optimization according to embodiments of the present disclosure.

### DETAILED DESCRIPTION

The following disclosure describes various embodiments for system 100 and accompanying methods for providing neural network model definition code generation and optimization. In particular, embodiments disclosed herein provide the capability to generate an artificial intelligence model based on various options selected by a user, convert freehand drawings into executable model definitions supporting the operative functionality of an artificial intelligence model, set properties for the models, and optimize the artificial intelligence model in real-time by intelligently locating higher performing modules (e.g., software for performing a specific task or set of artificial intelligence and/or other tasks) for inclusion into the existing artificial intelligence model generated by the system 100 and methods. Currently, when developing an artificial intelligence model from the ground up, data scientists, engineers, or software developers brainstorm together and discuss the potential blocks, layers, and modules for inclusion into the artificial intelligence model. Additionally, when developing the artificial intelligence model, the developers of the model factor in the datasets and artificial intelligence tasks that the artificial intelligence model need to perform to effectively gain insight, inference, and intelligence resulting from the operation of the software code supporting the functionality of the artificial intelligence model. Once the developers have an idea of the type of model to develop and the types of artificial intelligence tasks to perform using the model (e.g., image classification, segmentation, content-based image retrieval, etc.), the developers may draw the graph for the model on a whiteboard, write the model definition (e.g., script), and then draw the flowchart for a report or paper (e.g., white paper).

According to embodiments of the present disclosure, the system 100 and methods provide a tool to generate the code (e.g., model definition) and a clean neural network model graph illustrating the various blocks, layers, models, connections, or a combination thereof, of the artificial intelligence model. In generating the graph and model, the system 100 may consider a variety of input sources to facilitate the generation of the graph and model. For example, the system 100 and methods may receive imported modules, drawings of modules and models, documents, modules from online repositories, modules obtained via neural architectures search, system profile information associated with the system 100, and other inputs, as factor in the development of the model. In certain embodiments, the system 100 and methods are capable of calculating, in real-time, the artificial intelligence model's number of operations and parameters. Knowing the number of operations and parameters is often an important part of designing a neural network and artificial intelligence models operating therein to ensure that the models are capable of performing tasks efficiently and accurately. In certain embodiments, the system 100 and methods may also provide the ability to adjust the number of operations and parameters in real-time as the system 100 or users change modules, layers, and/or blocks of the model. Currently existing technologies are incapable of providing such functionality during the development of the artificial intelligence model.

Once the system 100 and methods generate an artificial intelligence model, the system 100 and methods provide further functionality to further optimize the model over time. For example, the system 100 and methods are capable of optimizing the graph and the model to make the model more efficient and increase the model's information density by reducing operations and parameters, while simultaneously maintaining similar accuracy level or higher. In certain embodiments, the system 100 and methods may utilize predefined modules capable of achieving the foregoing or perform neural architecture search to suggest more efficient modules for inclusion into the model. In certain embodiments, the system 100 and methods may enable users to just draw small blocks instead of defining exact layers of the artificial intelligence model. Then, the system and methods 100 may employ the use of a crawler that will search repositories (e.g., GitHub) and extract the state-of-the-art modules available and automatically integrate the modules into the model definition for the user. Furthermore, the system 100 and methods may use papers or document descriptions as inputs to guide module creation through a neural network.

In certain embodiments, a system for providing neural network model definition code generation and optimization is provided. In certain embodiments, the system may include a memory and a processor configured to perform various operations and support the functionality of the system. In certain embodiments, the processor may be configured to facilitate, by utilizing a neural network, selection of a plurality of modules for inclusion in an artificial intelligence model to be generated by the system. Additionally, the processor may be configured to facilitate, by utilizing the neural network, selection of one or more properties for each module of the plurality of modules for the artificial intelligence model. Furthermore, the processor may be configured to establish, by utilizing the neural network, a connection between each module selected from the plurality of modules with at least one other module selected from the plurality of modules. Still further, the processor may be configured to generate, by utilizing a neural network and based on the selection of the property for each module and the connection, a model definition for the artificial intelligence model by generating code for each module selected from the plurality of modules. Moreover, the processor may be configured to execute a task (e.g., a computer vision task or any other task) by utilizing the artificial intelligence model via the model definition generated via the code for each module selected from the plurality of modules.

In certain embodiments, the processor may be further configured to update a parameter for at least one module of the plurality of modules of the artificial intelligence module after adding an additional module to or removing a module from the artificial intelligence model. In certain embodiments, the processor may be further configured to update an operation for at least one module of the plurality of modules of the artificial intelligence model after adding an additional module to or removing a module from the artificial intelligence model. In certain embodiments, the processor may be further configured to visually render a graph for the artificial intelligence model including a visual representation of each module of the plurality of modules selected for inclusion in the artificial intelligence model. In certain embodiments, the plurality of modules for inclusion in the artificial intelligence model may be pre-defined modules, custom-generated modules, or a combination thereof. In certain embodiments, the processor may be further configured to identify at least one module of the plurality of modules of the artificial intelligence model for replacement. In certain embodiments, the processor may be further configured to conduct a neural architecture search in a plurality of repositories to identify at least one replacement module to replace the at least one module for replacement.

In certain embodiments, the processor may be further configured to automatically modify the artificial intelligence model based on a change in the task to be performed by the artificial intelligence model. In certain embodiments, the processor may be further configured to receive a manually drawn artificial intelligence model comprising manually drawn modules. In certain embodiments, the processor may be further configured to extract text from each block in the manually drawn artificial intelligence model and may be further configured to identify at least one module from the plurality of modules correlating with the text. In certain embodiments, the processor may be further configured to generate a different model definition corresponding to the manually drawn artificial intelligence model and including the at least one module from the plurality of modules correlating with the text. In certain embodiments, the processor may be further configured to import the plurality of modules from a search space including a module collection.

In certain embodiments, a method for providing neural network model definition code generation and optimization is provided. In certain embodiments, the method may include receiving, by utilizing a neural network, manually generated content serving as an input for generation of an artificial intelligence model. Additionally, the method may include extracting, by utilizing the neural network, text associated with the manually generated content. The method may also include detecting, by utilizing the neural network, a portion of the content within the manually generated content indicative of a visual representation of at least one module of the artificial intelligence model. The method may also include generating, by utilizing the neural network, a graph of the artificial intelligence model using the text and the portion of the content indicative of the visual representation of the artificial intelligence model. Furthermore, the method may include generating, by utilizing the neural network and based on the graph of the artificial intelligence model, a model definition for the artificial intelligence model by generating code for the artificial intelligence model. Moreover, the method may include executing, by utilizing the neural network, the model definition for the artificial intelligence model to perform a task.

In certain embodiments, the method may further include generating the model definition for the artificial intelligence model by obtaining, via a neural architecture search, candidate modules for the artificial intelligence module from a repository. In certain embodiments, the method may further include enabling selection of at least one property of the artificial intelligence model via an interface of an application associated with the neural network. In certain embodiments, the method may further include displaying the code generated for the artificial intelligence model via a user interface. In certain embodiments, the method may further include enabling selection of the at least one module of the artificial intelligence model for replacement by at least one other module. In certain embodiments, the method may further include providing an option to adjust an intensity level for reducing operations or parameters associated with the artificial intelligence model. In certain embodiments, the method may further include providing a digital canvas to enable drawing of blocks, connections, modules, or a combination thereof, associated with the artificial intelligence model.

In certain embodiments, a device for providing neural network model definition code generation and optimization is provided. The device may include a processor that stores instructions and a processor that executes the instructions to perform various operations of the device. In certain embodiments, the processor may be configured to identify, by utilizing a neural network, a task to be completed by an artificial intelligence model. In certain embodiments, the processor may be configured to search, by utilizing the neural network, for a plurality of modules and content in a plurality of repositories. In certain embodiments, the processor may be configured to extract, by utilizing the neural network, a portion of the content from the content that is associated with the task, the artificial intelligence model, or a combination thereof. In certain embodiments, the processor may be configured to select, by utilizing the neural network, a set of candidate modules of the plurality of modules in the plurality of repositories based on a matching characteristics of the set of candidate modules with the task. In certain embodiments, the processor may be configured to generate the artificial intelligence model based on the portion of the content and the set of candidate modules. In certain embodiments, the processor may be configured to execute the task using the artificial intelligence model.

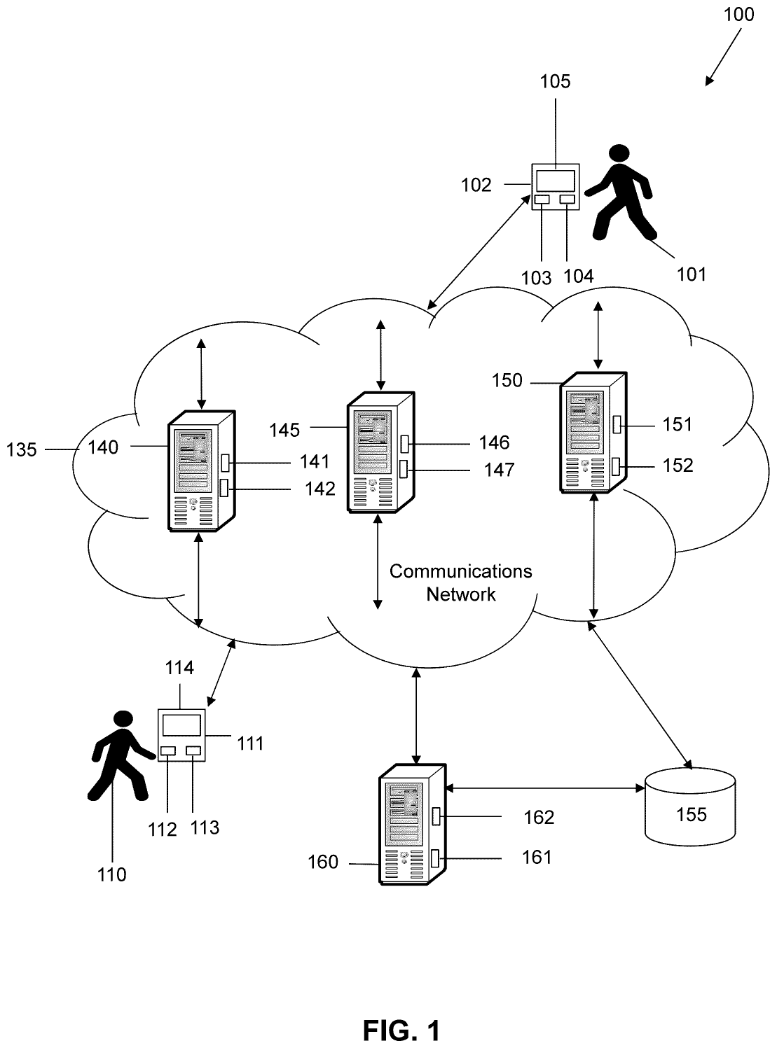

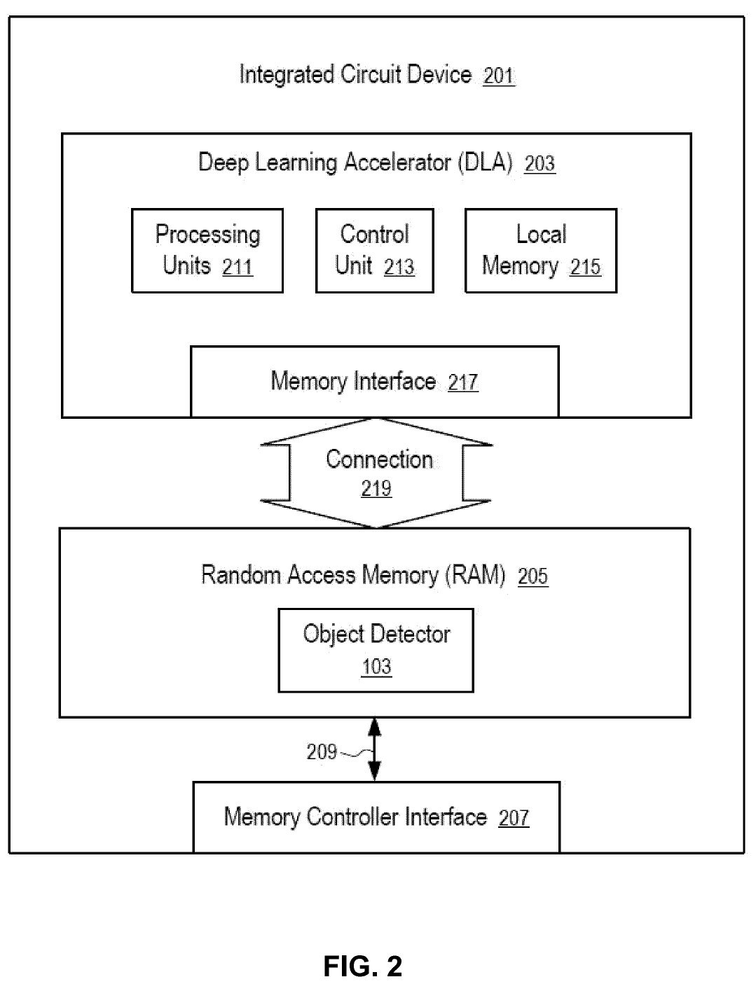

As shown in FIG. 1 and referring also to FIGS. 2-13, a system 100 for providing neural network model definition code generation and optimization is provided. Notably, the system 100 may be configured to support, but is not limited to supporting, code generation systems and services, automated artificial intelligence model generation systems and services, artificial intelligence model optimization systems and services, neural architecture search, data analytics systems and services, data collation and processing systems and services, artificial intelligence services and systems, machine learning services and systems, neural network services, vision transformer-based services, convolutional neural network (CNN)-based services, security systems and services, surveillance and monitoring systems and services, autonomous vehicle applications and services, mobile applications and services, alert systems and services, content delivery services, cloud computing services, satellite services, telephone services, voice-over-internet protocol services (VoIP), software as a service (SaaS) applications, platform as a service (PaaS) applications, gaming applications and services, social media applications and services, operations management applications and services, productivity applications and services, and/or any other computing applications and services. Notably, the system 100 may include a first user 101, who may utilize a first user device 102 to access data, content, and services, or to perform a variety of other tasks and functions. As an example, the first user 101 may utilize first user device 102 to transmit signals to access various online services and content, such as those available on an internet, on other devices, and/or on various computing systems. As another example, the first user device 102 may be utilized to access an application, devices, and/or components of the system 100 that provide any or all of the operative functions of the system 100. In certain embodiments, the first user 101 may be a person, a robot, a humanoid, a program, a computer, any type of user, or a combination thereof, that may be located in a particular environment. In certain embodiments, the first user 101 may be a person that may want to utilize the first user device 102 to conduct various types of artificial intelligence tasks by utilizing neural networks. For example, such tasks may be computer vision tasks, such as, but not limited to, image classification, object detection, image segmentation, among other computer vision tasks. For example, the first user 101 may seek to identify objects existing within an environment and the first user 101 may take images and/or video content of the environment, which may be processed by utilizing neural networks accessible by the first user device 102. As a further example, the first user 101 may be a person that may seek to generate an artificial intelligence model from manually drawn sketches, written text, computer images (or other content), documents, artificial intelligence modules found in repositories, or a combination thereof.

The first user device 102 may include a memory 103 that includes instructions, and a processor 104 that executes the instructions from the memory 103 to perform the various operations that are performed by the first user device 102. In certain embodiments, the processor 104 may be hardware, software, or a combination thereof. The first user device 102 may also include an interface 105 (e.g. screen, monitor, graphical user interface, etc.) that may enable the first user 101 to interact with various applications executing on the first user device 102 and to interact with the system 100. In certain embodiments, the first user device 102 may be and/or may include a computer, any type of sensor, a laptop, a set-top-box, a tablet device, a phablet, a server, a mobile device, a smartphone, a smart watch, an autonomous vehicle, and/or any other type of computing device. Illustratively, the first user device 102 is shown as a smartphone device in FIG. 1. In certain embodiments, the first user device 102 may be utilized by the first user 101 to control and/or provide some or all of the operative functionality of the system 100.

In addition to using first user device 102, the first user 101 may also utilize and/or have access to additional user devices. As with first user device 102, the first user 101 may utilize the additional user devices to transmit signals to access various online services and content, record various content, and/or access functionality provided by one or more neural networks. The additional user devices may include memories that include instructions, and processors that executes the instructions from the memories to perform the various operations that are performed by the additional user devices. In certain embodiments, the processors of the additional user devices may be hardware, software, or a combination thereof. The additional user devices may also include interfaces that may enable the first user 101 to interact with various applications executing on the additional user devices and to interact with the system 100. In certain embodiments, the first user device 102 and/or the additional user devices may be and/or may include a computer, any type of sensor, a laptop, a set-top-box, a tablet device, a phablet, a server, a mobile device, a smartphone, a smart watch, an autonomous vehicle, and/or any other type of computing device, and/or any combination thereof. Sensors may include, but are not limited to, cameras, motion sensors, acoustic/audio sensors, pressure sensors, temperature sensors, light sensors, humidity sensors, any type of sensors, or a combination thereof.

The first user device 102 and/or additional user devices may belong to and/or form a communications network. In certain embodiments, the communications network may be a local, mesh, or other network that enables and/or facilitates various aspects of the functionality of the system 100. In certain embodiments, the communications network may be formed between the first user device 102 and additional user devices through the use of any type of wireless or other protocol and/or technology. For example, user devices may communicate with one another in the communications network by utilizing any protocol and/or wireless technology, satellite, fiber, or any combination thereof. Notably, the communications network may be configured to communicatively link with and/or communicate with any other network of the system 100 and/or outside the system 100.

In certain embodiments, the first user device 102 and additional user devices belonging to the communications network may share and exchange data with each other via the communications network. For example, the user devices may share information relating to the various components of the user devices, information associated with images and/or content accessed and/or recorded by a user of the user devices, information identifying the locations of the user devices, information indicating the types of sensors that are contained in and/or on the user devices, information identifying the applications being utilized on the user devices, information identifying how the user devices are being utilized by a user, information identifying user profiles for users of the user devices, information identifying device profiles for the user devices, information identifying the number of devices in the communications network, information identifying devices being added to or removed from the communications network, any other information, or any combination thereof.

In addition to the first user 101, the system 100 may also include a second user 110. The second user 110 may be similar to the first user 101, but may seek to do image classification, segmentation, and/or other computer vision-related tasks in a different environment and/or with a different user device, such as second user device 111. In certain embodiments, the second user 110 may be a user that may seek to automatically create an artificial intelligence model for performing one or more artificial intelligence tasks. In certain embodiments, the second user device 111 may be utilized by the second user 110 to transmit signals to request various types of content, services, and data provided by and/or accessible by communications network 135 or any other network in the system 100. In further embodiments, the second user 110 may be a robot, a computer, a vehicle (e.g. semi or fully-automated vehicle), a humanoid, an animal, any type of user, or any combination thereof. The second user device 111 may include a memory 112 that includes instructions, and a processor 113 that executes the instructions from the memory 112 to perform the various operations that are performed by the second user device 111. In certain embodiments, the processor 113 may be hardware, software, or a combination thereof. The second user device 111 may also include an interface 114 (e.g. screen, monitor, graphical user interface, etc.) that may enable the first user 101 to interact with various applications executing on the second user device 111 and, in certain embodiments, to interact with the system 100. In certain embodiments, the second user device 111 may be a computer, a laptop, a set-top-box, a tablet device, a phablet, a server, a mobile device, a smartphone, a smart watch, an autonomous vehicle, and/or any other type of computing device. Illustratively, the second user device 111 is shown as a mobile device in FIG. 1. In certain embodiments, the second user device 111 may also include sensors, such as, but are not limited to, cameras, audio sensors, motion sensors, pressure sensors, temperature sensors, light sensors, humidity sensors, any type of sensors, or a combination thereof.

In certain embodiments, the first user device 102, the additional user devices, and/or the second user device 111 may have any number of software functions, applications and/or application services stored and/or accessible thereon. For example, the first user device 102, the additional user devices, and/or the second user device 111 may include applications for controlling and/or accessing the operative features and functionality of the system 100, applications for accessing and/or utilizing neural networks of the system 100, applications for controlling and/or accessing any device of the system 100, neural architecture search applications, interactive social media applications, biometric applications, cloud-based applications, VoIP applications, other types of phone-based applications, product-ordering applications, business applications, e-commerce applications, media streaming applications, content-based applications, media-editing applications, database applications, gaming applications, internet-based applications, browser applications, mobile applications, service-based applications, productivity applications, video applications, music applications, social media applications, any other type of applications, any types of application services, or a combination thereof. In certain embodiments, the software applications may support the functionality provided by the system 100 and methods described in the present disclosure. In certain embodiments, the software applications and services may include one or more graphical user interfaces so as to enable the first and/or second users 101, 110 to readily interact with the software applications. The software applications and services may also be utilized by the first and/or second users 101, 110 to interact with any device in the system 100, any network in the system 100, or any combination thereof. In certain embodiments, the first user device 102, the additional user devices, and/or potentially the second user device 111 may include associated telephone numbers, device identities, or any other identifiers to uniquely identify the first user device 102, the additional user devices, and/or the second user device 111.

The system 100 may also include a communications network 135. The communications network 135 may be under the control of a service provider, the first user 101, any other designated user, a computer, another network, or a combination thereof. The communications network 135 of the system 100 may be configured to link each of the devices in the system 100 to one another. For example, the communications network 135 may be utilized by the first user device 102 to connect with other devices within or outside communications network 135. Additionally, the communications network 135 may be configured to transmit, generate, and receive any information and data traversing the system 100. In certain embodiments, the communications network 135 may include any number of servers, databases, or other componentry. The communications network 135 may also include and be connected to a neural network, a mesh network, a local network, a cloud-computing network, an IMS network, a VoIP network, a security network, a VoLTE network, a wireless network, an Ethernet network, a satellite network, a broadband network, a cellular network, a private network, a cable network, the Internet, an internet protocol network, MPLS network, a content distribution network, any network, or any combination thereof. Illustratively, servers 140, 145, and 150 are shown as being included within communications network 135. In certain embodiments, the communications network 135 may be part of a single autonomous system that is located in a particular geographic region, or be part of multiple autonomous systems that span several geographic regions.

Notably, the functionality of the system 100 may be supported and executed by using any combination of the servers 140, 145, 150, and 160. The servers 140, 145, and 150 may reside in communications network 135, however, in certain embodiments, the servers 140, 145, 150 may reside outside communications network 135. The servers 140, 145, and 150 may provide and serve as a server service that performs the various operations and functions provided by the system 100. In certain embodiments, the server 140 may include a memory 141 that includes instructions, and a processor 142 that executes the instructions from the memory 141 to perform various operations that are performed by the server 140. The processor 142 may be hardware, software, or a combination thereof. Similarly, the server 145 may include a memory 146 that includes instructions, and a processor 147 that executes the instructions from the memory 146 to perform the various operations that are performed by the server 145. Furthermore, the server 150 may include a memory 151 that includes instructions, and a processor 152 that executes the instructions from the memory 151 to perform the various operations that are performed by the server 150. In certain embodiments, the servers 140, 145, 150, and 160 may be network servers, routers, gateways, switches, media distribution hubs, signal transfer points, service control points, service switching points, firewalls, routers, edge devices, nodes, computers, mobile devices, or any other suitable computing device, or any combination thereof. In certain embodiments, the servers 140, 145, 150 may be communicatively linked to the communications network 135, any network, any device in the system 100, or any combination thereof.

The database 155 of the system 100 may be utilized to store and relay information that traverses the system 100, cache content that traverses the system 100, store data about each of the devices in the system 100 and perform any other typical functions of a database. In certain embodiments, the database 155 may be connected to or reside within the communications network 135, any other network, or a combination thereof. In certain embodiments, the database 155 may serve as a central repository for any information associated with any of the devices and information associated with the system 100. Furthermore, the database 155 may include a processor and memory or may be connected to a processor and memory to perform the various operations associated with the database 155. In certain embodiments, the database 155 may be connected to the servers 140, 145, 150, 160, the first user device 102, the second user device 111, the additional user devices, any devices in the system 100, any process of the system 100, any program of the system 100, any other device, any network, or any combination thereof.

The database 155 may also store information and metadata obtained from the system 100, store metadata and other information associated with the first and second users 101, 110, store hand-drawn modules, connections, and/or graphs, store parameters and/or operations for a model, store properties selected for a module and/or model, store written descriptions utilized to generate the modules and/or models, store content utilized to generate the modules and/or models, store neural architecture searches conducted for locating models and/or modules, store system profiles, store datasets, store architectures, input sizes, target devices, and/or tasks associated with an artificial intelligence model and/or module, store modules, store layers, store blocks, store runtime execution values, store accuracy values relating to the modules, store information relating to tasks to be performed by models and/or modules, store artificial intelligence/neural network models utilized in the system 100, store sensor data and/or content obtained from an environment, store predictions made by the system 100 and/or artificial intelligence/neural network models, storing confidence scores relating to predictions made, store threshold values for confidence scores, responses outputted and/or facilitated by the system 100 and, store information associated with anything detected via the system 100, store information and/or content utilized to train the artificial intelligence/neural network models, store user profiles associated with the first and second users 101, 110, store device profiles associated with any device in the system 100, store communications traversing the system 100, store user preferences, store information associated with any device or signal in the system 100, store information relating to patterns of usage relating to the user devices 102, 111, store any information obtained from any of the networks in the system 100, store historical data associated with the first and second users 101, 110, store device characteristics, store information relating to any devices associated with the first and second users 101, 110, store information associated with the communications network 135, store any information generated and/or processed by the system 100, store any of the information disclosed for any of the operations and functions disclosed for the system 100 herewith, store any information traversing the system 100, or any combination thereof. Furthermore, the database 155 may be configured to process queries sent to it by any device in the system 100.

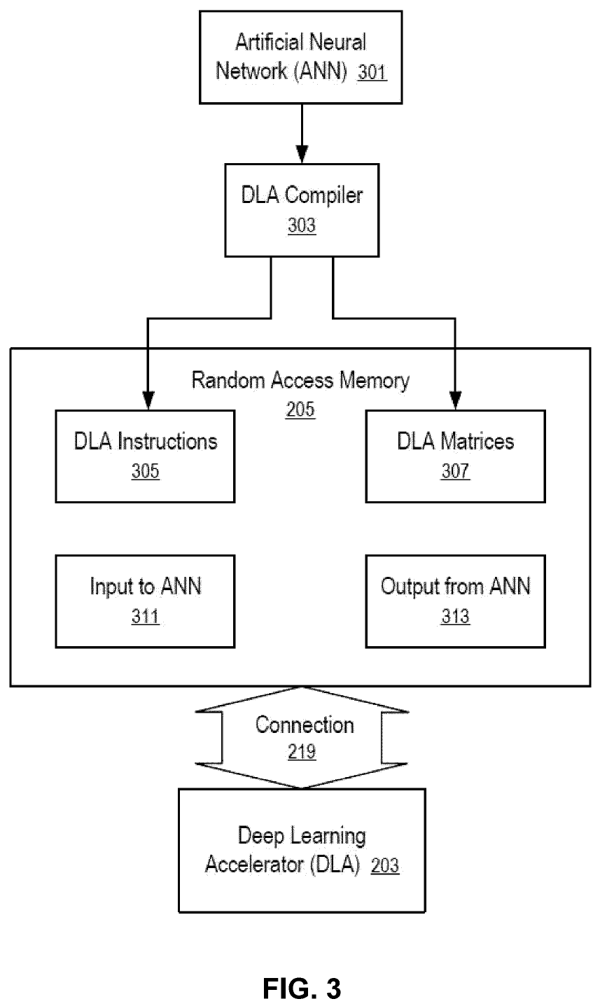

Referring now also to FIG. 2, an exemplary integrated circuit device 201 and accompanying componentry that may be utilized by a neural network, modules, and models of the present disclosure to facilitate neural network model definition code generation and optimization is provided. In certain embodiments, the integrated circuit device 201 may include a deep learning accelerator 203 and a memory 205 (e.g., random access memory or other memory). In certain embodiments, the deep learning accelerator 203 may be hardware and may have specifications and features designed to accelerate artificial intelligence and machine learning processes and enhance performance of artificial intelligence models and modules contained therein. In certain embodiments, the deep learning accelerator 203 may be configured to accelerate deep learning workloads and computations. In certain embodiments, the memory 205 may include an object detector 103. For example, the object detector 103 may include a neural network structure. In certain embodiments, a description of the object detector 103 may be compiled by a compiler to generate instructions for execution by the deep learning accelerator 203 and matrices to be used by the instructions. In certain embodiments, the object detector 103 in the memory 205 may include the instructions 305 and the matrices 307 generated by the compiler 303, as further discussed below in connection with FIG. 3. In certain embodiments, the deep learning accelerator 203 may include processing units 211, a control unit 213, and local memory 215. When vector and matrix operands are in the local memory 215, the control unit 213 may use the processing units 211 to perform vector and matrix operations in accordance with instructions. In certain embodiments, the control unit 213 can load instructions and operands from the memory 205 through a memory interface 217 and a high speed bandwidth connection 219.

In certain embodiments, the integrated circuit device 201 may be configured to be enclosed within an integrated circuit package with pins or contacts for a memory controller interface 207. In certain embodiments, the memory controller interface 207 may be configured to support a standard memory access protocol such that the integrated circuit device 201 appears to a typical memory controller in a way same as a conventional random access memory device having no deep learning accelerator 203. For example, a memory controller external to the integrated circuit device 201 may access, using a standard memory access protocol through the memory controller interface 207, the memory 205 in the integrated circuit device 201. In certain embodiments, the integrated circuit device 201 may be configured with a high bandwidth connection 219 between the memory 205 and the deep learning accelerator 203 that are enclosed within the integrated circuit device 201. In certain embodiments, bandwidth of the connection 219 is higher than the bandwidth of the connection 209 between the random access memory 205 and the memory controller interface 207.

In certain embodiments, both the memory controller interface 207 and the memory interface 217 may be configured to access the memory 205 via a same set of buses or wires. In certain embodiments, the bandwidth to access the memory 205 may be shared between the memory interface 217 and the memory controller interface 207. In certain embodiments, the memory controller interface 207 and the memory interface 217 may be configured to access the memory 205 via separate sets of buses or wires. In certain embodiments, the memory 205 may include multiple sections that can be accessed concurrently via the connection 219. For example, when the memory interface 217 is accessing a section of the memory 205, the memory controller interface 207 may concurrently access another section of the memory 205. For example, the different sections can be configured on different integrated circuit dies and/or different planes/banks of memory cells; and the different sections can be accessed in parallel to increase throughput in accessing the memory 205. For example, the memory controller interface 207 may be configured to access one data unit of a predetermined size at a time; and the memory interface 217 is configured to access multiple data units, each of the same predetermined size, at a time.

In certain embodiments, the memory 205 and the integrated circuit device 201 may be configured on different integrated circuit dies configured within a same integrated circuit package. In certain embodiments, the memory 205 may be configured on one or more integrated circuit dies that allows parallel access of multiple data elements concurrently. In certain embodiments, the number of data elements of a vector or matrix that may be accessed in parallel over the connection 219 corresponds to the granularity of the deep learning accelerator operating on vectors or matrices. For example, when the processing units 211 may operate on a number of vector/matrix elements in parallel, the connection 219 may be configured to load or store the same number, or multiples of the number, of elements via the connection 219 in parallel. In certain embodiments, the data access speed of the connection 219 may be configured based on the processing speed of the deep learning accelerator 203. For example, after an amount of data and instructions have been loaded into the local memory 215, the control unit 213 may execute an instruction to operate on the data using the processing units 211 to generate output. Within the time period of processing to generate the output, the access bandwidth of the connection 219 may allow the same amount of data and instructions to be loaded into the local memory 215 for the next operation and the same amount of output to be stored back to the random access memory 205. For example, while the control unit 213 is using a portion of the local memory 215 to process data and generate output, the memory interface 217 can offload the output of a prior operation into the random access memory 205 from, and load operand data and instructions into, another portion of the local memory 215. Thus, the utilization and performance of the deep learning accelerator 203 may not be restricted or reduced by the bandwidth of the connection 219.

In certain embodiments, the memory 205 may be used to store the model data of a neural network and to buffer input data for the neural network. The model data may include the output generated by a compiler for the deep learning accelerator 203 to implement the neural network. The model data may include matrices used in the description of the neural network and instructions generated for the deep learning accelerator 203 to perform vector/matrix operations of the neural network based on vector/matrix operations of the granularity of the deep learning accelerator 203. The instructions may operate not only on the vector/matrix operations of the neural network, but also on the input data for the neural network. In certain embodiments, when the input data is loaded or updated in the memory 205, the control unit 213 of the deep learning accelerator 203 may automatically execute the instructions for the neural network to generate an output for the neural network. The output may be stored into a predefined region in the memory 205. The deep learning accelerator 203 may execute the instructions without help from a central processing unit (CPU). Thus, communications for the coordination between the deep learning accelerator 203 and a processor outside of the integrated circuit device 201 (e.g., a Central Processing Unit (CPU)) can be reduced or eliminated.

In certain embodiments, the memory 205 can be volatile memory or non-volatile memory, or a combination of volatile memory and non-volatile memory. Examples of non-volatile memory include flash memory, memory cells formed based on negative-and (NAND) logic gates, negative-or (NOR) logic gates, Phase-Change Memory (PCM), magnetic memory (MRAM), resistive random-access memory, cross point storage and memory devices. A cross point memory device can use transistor-less memory elements, each of which has a memory cell and a selector that are stacked together as a column. Memory element columns are connected via two lays of wires running in perpendicular directions, where wires of one lay run in one direction in the layer that is located above the memory element columns, and wires of the other lay run in another direction and are located below the memory element columns. Each memory element can be individually selected at a cross point of one wire on each of the two layers. Cross point memory devices are fast and non-volatile and can be used as a unified memory pool for processing and storage. Further examples of non-volatile memory include Read-Only Memory (ROM), Programmable Read-Only Memory (PROM), Erasable Programmable Read-Only Memory (EPROM) and Electronically Erasable Programmable Read-Only Memory (EEPROM) memory, etc. Examples of volatile memory include Dynamic Random-Access Memory (DRAM) and Static Random-Access Memory (SRAM).

For example, non-volatile memory can be configured to implement at least a portion of the memory 205. The non-volatile memory in the memory 205 may be used to store the model data of a neural network. Thus, after the integrated circuit device 201 is powered off and restarts, it is not necessary to reload the model data of the neural network into the integrated circuit device 201. Further, the non-volatile memory may be programmable/rewritable. Thus, the model data of the neural network in the integrated circuit device 201 may be updated or replaced to implement an updated neural network or another neural network.

Referring now also to FIG. 3, an exemplary deep learning accelerator 203 and memory 205 configured to apply inputs to a trained artificial neural network for performing tasks is shown. In certain embodiments, an artificial neural network 301 may be trained through machine learning (e.g., deep learning) to implement an artificial intelligence model and modules included therein. A description of the trained artificial neural network 301 in a standard format may identify the properties of the artificial neurons and their connectivity. In certain embodiments, the compiler 303 may convert trained artificial neural network 301 by generating instructions 305 for a deep learning accelerator 203 and matrices 307 corresponding to the properties of the artificial neurons and their connectivity. In certain embodiments, the instructions 305 and the matrices 307 generated by the compiler 303 from the trained artificial neural network 301 may be stored in memory 205 for the deep learning accelerator 203. For example, the memory 205 and the deep learning accelerator 203 may be connected via a high bandwidth connection 219 in a way as in the integrated circuit device 201. The computations of the artificial neural network 301 may be based on the instructions 305 and the matrices 307 may be implemented in the integrated circuit device 201. In certain embodiments, the memory 205 and the deep learning accelerator 203 may be configured on a printed circuit board with multiple point to point serial buses running in parallel to implement the connection 219.

In certain embodiments, after the results of the compiler 303 are stored in the memory 205, the application of the trained artificial neural network 301 to process an input 311 to the trained artificial neural network 301 to generate the corresponding output 313 of the trained artificial neural network 301 may be triggered by the presence of the input 311 in the memory 205, or another indication provided in the memory 205. In response, the deep learning accelerator 203 executes the instructions 305 to combine the input 311 and the matrices 307. The matrices 307 may include kernel matrices to be loaded into kernel buffers and maps matrices to be loaded into maps banks. The execution of the instructions 305 can include the generation of maps matrices for the maps banks of one or more matrix-matrix units of the deep learning accelerator 203. In certain embodiments, the inputs to artificial neural network 301 is in the form of an initial maps matrix. Portions of the initial maps matrix can be retrieved from the memory 205 as the matrix operand stored in the maps banks of a matrix-matrix unit. In certain embodiments, the instructions 305 also include instructions for the deep learning accelerator 203 to generate the initial maps matrix from the input 311. Based on the instructions 305, the deep learning accelerator 203 may load matrix operands into kernel buffers and maps banks of its matrix-matrix unit. The matrix-matrix unit performs the matrix computation on the matrix operands. For example, the instructions 305 break down matrix computations of the trained artificial neural network 301 according to the computation granularity of the deep learning accelerator 203 (e.g., the sizes/dimensions of matrices that loaded as matrix operands in the matrix-matrix unit) and applies the input feature maps to the kernel of a layer of artificial neurons to generate output as the input for the next layer of artificial neurons.

Upon completion of the computation of the trained artificial neural network 301 performed according to the instructions 305, the deep learning accelerator 203 may store the output 313 of the artificial neural network 301 at a pre-defined location in the memory 205, or at a location specified in an indication provided in the memory 205 to trigger the computation. In certain embodiments, an external device connected to the memory controller interface 207 can write the input 311 (e.g., an image) into the memory 205 and trigger the computation of applying the input 311 to the trained artificial neural network 301 by the deep learning accelerator 203. After a period of time, the output 313 (e.g., a classification) is available in the memory 205 and the external device can read the output 313 via the memory controller interface 207 of the integrated circuit device 201. For example, a predefined location in the memory 205 can be configured to store an indication to trigger the execution of the instructions 305 by the deep learning accelerator 203. The indication can include a location of the input 311 within the memory 205. Thus, during the execution of the instructions 305 to process the input 311, the external device can retrieve the output generated during a previous run of the instructions 305, and/or store another set of input for the next run of the instructions 305.

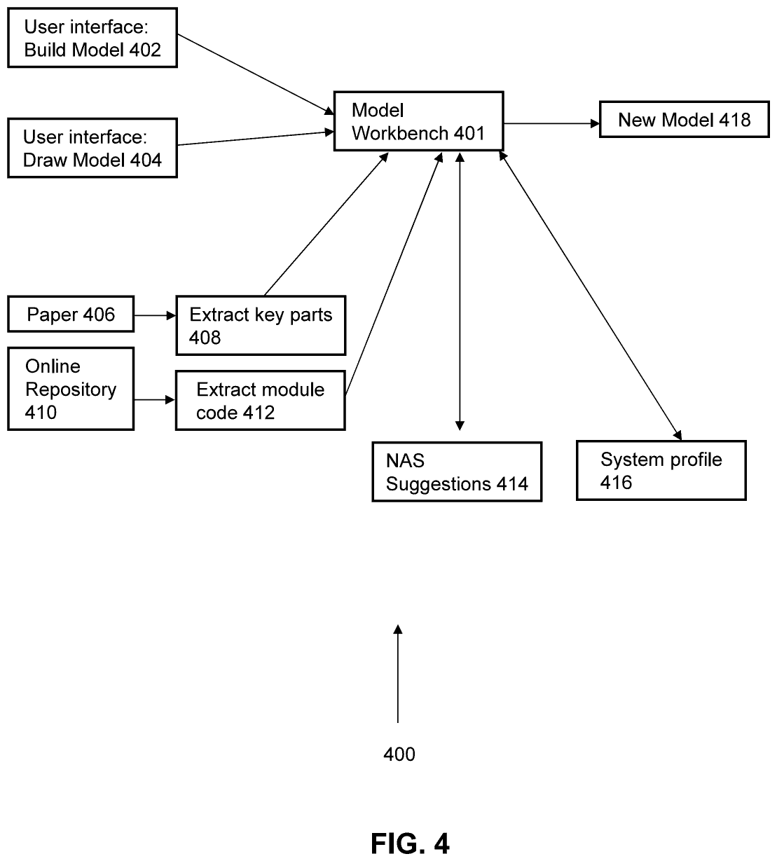

Referring now also to FIG. 4, an exemplary architecture 400 that may be utilized to generate an artificial intelligence model is schematically illustrated. In certain embodiments, the architecture 400 may include a model workbench 401, a user interface build model feature 402, a user interface draw model feature 404, various input sources (e.g., documents 406 (e.g., paper), online repositories 410, etc. from which key parts 408 may be extracted and module code 412 may be extracted respectively), neural architecture search functionality 414, a system profile 416, and the new artificial intelligence model 418 that is generated by and/or by utilizing the model workbench 401. In certain embodiments, the model workbench 401 may be software and/or hardware environment in which the artificial intelligence model is to be generated. The model workbench 401 may be configured to receive as inputs information from the build model feature 402, the draw model feature 404, the documents 406, the online repositories 410, the neural architecture search functionality 414, the system profile 416, other input sources, or a combination thereof. The workbench 410, in certain embodiments, may contain a code generator to generate software code for modules, layers, and/or blocks of a model, compile the code, test the code against datasets or distributions of datasets, or a combination thereof. In certain embodiments, the build model feature 402 may enable a user to select specific blocks, layers, and/or modules for inclusion within blocks or layers of an artificial intelligence model 418 to be generated by the system 100. In certain embodiments, the build model feature 402 may be visually rendered or otherwise presented on a user interface of an application supporting the functionality of the system 100. For example, the build model feature 402 may include a plurality of module options, layer options, block options, and the like in a drop down menu for selection, such as by first user 101 via first user device 102. As modules, blocks, and/or layers are selected by the first user 101, the selections may be displayed on the user interface for the first user 101 to visualize and confirm the user's selections. In certain embodiments, the application may also enable a user to select favorite modules, layers, and/or blocks and store the favorites in the system 100. In certain embodiments, the application may enable the user to generate custom modules, such as by enabling the user to upload code into the application, providing a link to a custom module that the application can access, or a combination thereof.

In certain embodiments, the draw model feature 404 may be visually rendered or otherwise presented on a user interface of the application supporting the functionality of the system 100. In certain embodiments, the draw model feature 404 may be presented as a digital canvas where the first user 101 or other user may draw, such as by utilizing drawing functionality of the application (e.g., using a cursor or other method for drawing), the modules, layers, and/or blocks, along with connections between and/or among the modules, layers, and/or blocks. For example, the first user 101 may draw the modules as boxes (or other design) and connections as lines with arrows between and/or among the boxes. In certain embodiments, the draw model feature 404 may also enable the first user 101 to insert text on the digital canvas, such as within or in a vicinity of the box (or other design). In certain embodiments, the draw model feature 404 may allow the first user 101 to specify properties of the modules and/or connections drawn on the canvas. In certain embodiments, the draw model feature 404 may include an upload link that allows the first user 101 to upload a drawing, digitally-drawn content, or a combination thereof.

In certain embodiments, other input sources for use in generating the artificial intelligence model may include documents 406, such as paper and/or digital documents. For example, the documents 406 may be written documents with text on them, scanned documents, digital documents (e.g., a Word document), scholarly articles on a topic (e.g., a white paper), news articles, websites, documents containing metadata that describes modules and/or features of modules, any type of document, or a combination thereof. At 408, the system 100 may be configured to extract information, such as, but not limited to, key text (e.g., keywords), meaning, sentiment, images, other information, or a combination thereof, from the documents 406. The extracted information may be utilized by the neural networks of the system 100 to identify developed modules correlating with the information, to identify modules that need to be retrieved that correlate with the information, to identify the layers, blocks, and/or modules of the artificial intelligence model to be generated, to identify the connections between and/or among the layers, blocks, and/or modules, or a combination thereof. Online repository 410 may be another source of input for facilitating generation of the artificial intelligence model 418. The online repository 410 may be any type of online data source (e.g., GitHub or other comparable repository), an offline data source, a collection of modules, a collection of models, any location with code to support the functionality of modules and/or models, or a combination thereof.

In certain embodiments, the system 100, such as by utilizing a neural network, may conduct neural architecture search 414 to identify candidate modules in various repositories online, offline, or a combination thereof. In certain embodiments, the neural network may conduct the neural architecture search 414 by analyzing the characteristics of an artificial intelligence task to be performed by the artificial intelligence model 418 to be created by the system 100 and conducting the search for modules in the repositories that have functionality to facilitate execution of the task based on comparing the characteristics to the functionality provided by the modules. For example, if the task is to detect the presence of an animal in an image, the system 100 may search for a module that is capable of performing vision transformer (or convolutional neural network or other functionality) functionality to facilitate the detection required for the task. In certain embodiments, the system 100 may also utilize system profile 416 information to facilitate the creation of the artificial intelligence model 418. In certain embodiments, the system profile 416 may include information identifying the computing resources (e.g., memory resources, processor resources, deep learning accelerator resources, any type of computing resources, or a combination thereof) of the system 100, information identifying components of the system 100, information identifying the type of tasks that the system 100 can perform, any type of information associated with the system 100, or a combination thereof. In certain embodiments, once the model workbench 401 has one or more inputs, the model workbench 401 may then be utilized to arrange and/or combine modules and generate code for the models to generate the new artificial intelligence model 418. Once the artificial intelligence model 418 is created, the system 100 may execute the artificial intelligence task to be performed.

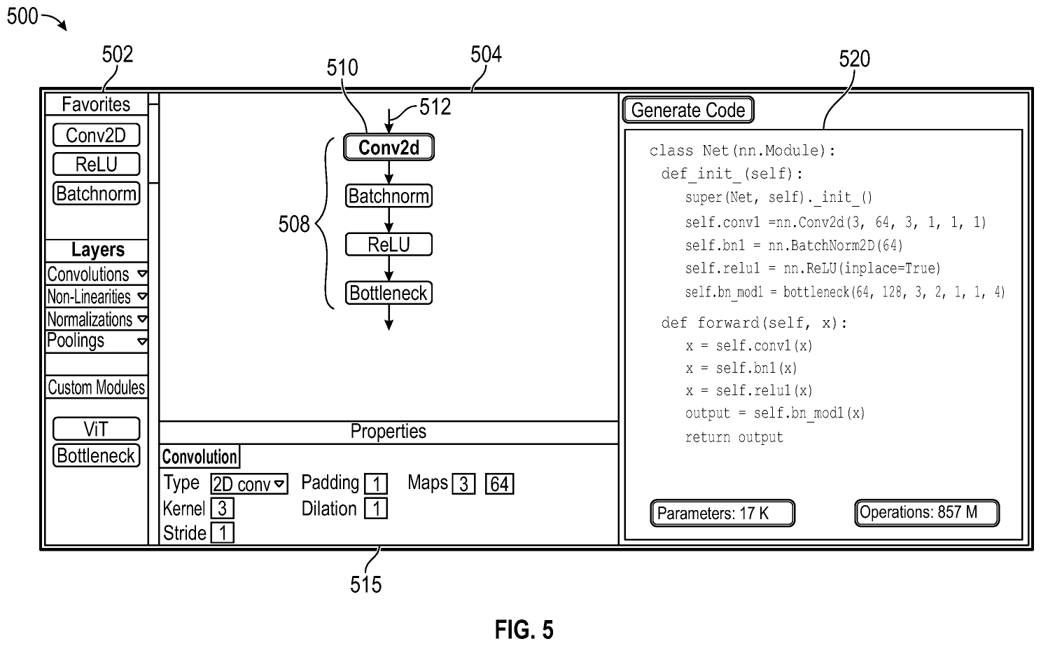

Referring now also to FIG. 5, an exemplary user interface 500 enabling creation of pre-defined or custom-built modules for an artificial intelligence model of the system 100 is schematically illustrated. In certain embodiments, the user interface 500 may be rendered for display on the device being utilized by a user, such as on the first user device 102 of the first user 101. In certain embodiments, the user interface 500 may include a first portion 502, a second portion 504, a third portion 515, and a fourth portion 515. In certain embodiments, the first portion 502 of the user interface 500 may include a section for selecting favorite modules for future reference, selection, or both. For example, the first user 101 may select several favorite modules, such as the two-dimensional convolutional module (“Conv2D”), a rectifier linear unit (ReLU) module, and a Batchnorm module, as shown in FIG. 5. The portion 502 may also include a plurality of potential layers or modules to select, such as based on type. For example, in FIG. 5, the types of layers that may be selected for a model may include convolutions, non-linearities, normalizations, poolings, and/or other layers. When a user clocks on the drop down menu for the types of layers, modules conforming to that particular type of layer may be listed for selection for inclusion in an artificial intelligence model. The first portion 502 may also include a section to upload custom modules. For example, in FIG. 5, the user may have uploaded a vision transformer (ViT) module and a Bottleneck module.

In certain embodiments, the second portion 504 may be the location where selected modules may be displayed. In certain embodiments, the application may enable the first user 101 to drag and drop pre-defined modules (or blocks and/or layers) or their own custom-built modules from the first portion 502 provided on the left of the user interface 500 and building a block diagram 508 of an artificial intelligence model. For example, the first user 101 may have selected the two-dimensional convolutional module (e.g., block 510), the Batchnorm module, the ReLU module, and the Bottlneck module for inclusion in the block diagram (e.g., graph) of the artificial intelligence module. In certain embodiments, the first user 101 may also specify the connections 512 between and/or among the selected modules. For each block or module selected for inclusion in the artificial intelligence model, one or more properties may be set, such as in the third portion 515. In certain embodiments, the system 100 itself may set the properties, however, in certain embodiments, the user may also set the embodiments. For example, if the convolutional module is selected, the user may set the kernel value, the stride value, the padding value, the dilation value, and the maps value. Other properties may also be set, such as, but not limited to, a maximum amount of computer resources to be used by a module, a type of task to be performed, any other properties, or a combination thereof. Once the properties are selected and/or set, the system 100 may enable generation of the code corresponding to each of the modules in the model. For example, the user may click on a generate code button and the system 100 may generate the code on the fly for the modules with the selected properties. Such code, for example, may be displayed in the fourth portion 520 of the user interface 500. In certain embodiments, as modules and/or layers are added to the model or removed from the model, the code may be updated in real-time. Additionally, the parameters (e.g., the number of parameters) and operations (e.g., the number of operations) for the model may also be updated in real-time.

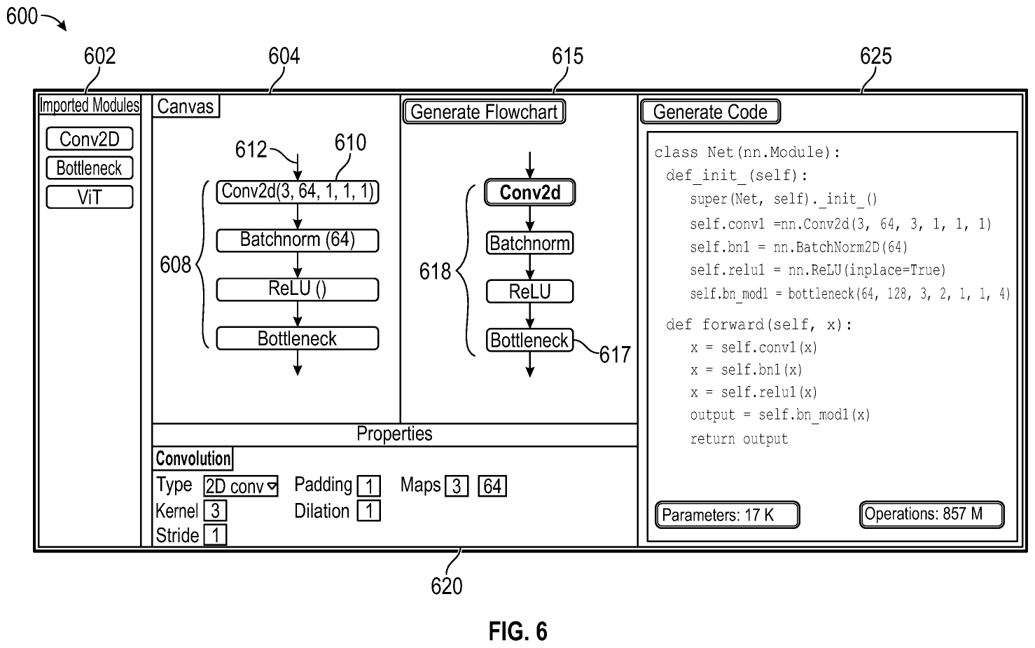

Referring now also to FIG. 6, an exemplary user interface 600 of an application enabling creation of artificial intelligence models from freehand or manually-generated images according to embodiments of the present disclosure is shown. In certain embodiments, the user interface 600 may be rendered for display on the device being utilized by a user, such as on the first user device 102 of the first user 101. In certain embodiments, the user interface 600 may include a first portion 602, a second portion 604, a third portion 615, a fourth portion 620, and a fifth portion 625. In certain embodiments, on top of the functionality provided in the user interface 500 of FIG. 5, the user interface 600 of the application may also allow the user to directly draw the block diagram (i.e., graph) freestyle or import images of the block diagram, which the user drew using their tablet (or other device) or even using conventional pen and paper into the digital canvas of the tool. The tool may be configured to automatically extract the written properties of each block but may allow the user to further refine and/or edit it using the “Properties” tab. A neural network may be used to detect the connections, and the boxes and another neural network can be used to identify the text in the boxes drawn in the canvas.

To that end, in certain embodiments, the first portion 602 may include a section to enable the importation of modules into the application. For example, as shown in FIG. 6, a convolutional two-dimensional module, a Bottleneck module, a vision transformer module, and other modules may be imported or uploaded into the application and information identifying the imported modules may be displayed in first portion 602. In certain embodiments, the second portion 604 may serve as a digital canvas where the first user 101 may draw images and write text to describe an artificial intelligence model, such as in a freestyle fashion. In certain embodiments, for example, the first user 101 may draw a graph 608 including rectangles (or other shapes) as an indication for each module, layer, and/or block (e.g., 610) of an artificial intelligence model to be generated by the system 100. In certain embodiments, information identifying each module, layer, and/or block may be written as text within the rectangles (or other shapes) to identify the type of module, layer, and/or block. Additionally, the first user 101 may specify various properties of the module, layer, and/or block by writing or drawing in values corresponding to such properties. In certain embodiments, the first user 101 may specify the property and a value adjacent to it. For example, in the two-dimensional convolutional drawn rectangle in second portion 604, the first user 101 may write properties adjacent to the text “Conv2d” (which identifies a two-dimensional convolutional module) and then the value 3 to signify the kernel value (e.g., size or other kernel value), 64 for the maps value, 1 for the stride value, 1 for the padding value, and 1 for the dilation value. Notably, any other types of parameters may also be specified as well. In certain embodiments, the first user 101 may also draw the connections 612 between and/or among each module, layer, and/or block of the graph 608 of the model.

In certain embodiments, for the third portion 615, the neural network of the system 100 may analyze the drawn graph 608 in the second portion 604 and automatically generate a formal graph 618 corresponding to the drawn graph 608. Additionally, the neural network may identify modules for the formal graph 618 based on the text analyzed and extracted from the graph 608. In certain embodiments, the neural network may utilize vision transformers, convolutional neural networks, natural language processing, and other techniques to identify the modules 610 and the corresponding parameters specified to generate the formal modules 617 of the formal graph 618. Similarly, the neural network may detect the connections 612 and make formal versions of the connections for the formal graph 618. In certain embodiments, the fourth portion 620 may be a section of the user interface 600 that enables the first user 101 or even the neural network to select the properties of each module, block, and/or layer of the artificial intelligence model to be generated by the system 100. For example, as shown in FIG. 6, the properties may include, but are not limited to, the type of module, the kernel value, the stride value, the padding value, the dilation value, and maps values. In certain embodiments, once the properties are set, the system 100 may, such as when the first user 101 selects the “generate code” button on the interface 600, generate and display the code for each module of the artificial intelligence model. The system 100 may also provide a real-time indication of the total amount of parameters for the model and the total number of operations. In certain embodiments, as modules, layers, and/or blocks are changed in the graph 608, the formal graph 618, or both, the parameter values and operation values in fifth portion 625 may be updated in real-time and the code may be adjusted in real-time as well. Similarly, as the properties are adjusted, the parameters and operations may be adjusted in real time, and the code may be adjusted in real-time as well. In certain embodiments, by being able to provide the real-time indication of the parameters, operations, or both, the system 100 is capable of estimating the computing resource requirements for each module of a model, the entire model itself, or both, on the fly during the model creation phase. For example, in FIG. 6, the exemplary model may have 17 thousand parameters and 857 million operations for the specific model configuration. Such estimation capabilities may enable the system to configure the model in an optimal fashion by selecting modules, blocks, layers, or a combination thereof, for the model that have lower parameters, operations, or both, while also ensuring same or better accuracy and runtime executions for performing artificial intelligence tasks. The system 100, in certain embodiments, may substitute any number of modules, layers, blocks, or a combination thereof, to maximize efficient use of computer resources.

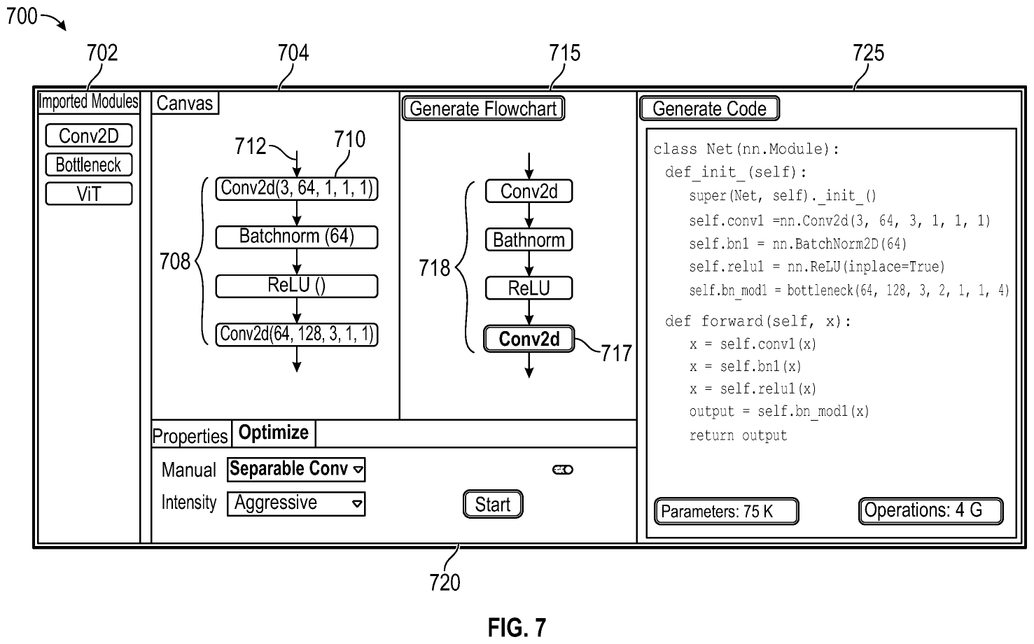

Referring now also to FIG. 7, an exemplary user interface 700 enabling optimization of an artificial intelligence model using neural architecture search is schematically illustrated. In certain embodiments, the user interface 700 may be rendered for display on the device being utilized by a user, such as on the first user device 102 of the first user 101. In certain embodiments, the user interface 700 may include a first portion 702, a second portion 704, a third portion 715, a fourth portion 720, and a fifth portion 725. In certain embodiments, the user interface 700 may provide access to similar functionality as the other user interfaces 500, 600, however, the user interface 700 may include further features and functionality. In particular, the user interface 700 may also provide for a feature to activate neural architecture search functionality to automatically update one or more layers, blocks, and/or modules of a generated artificial intelligence model, such as by searching various repositories, resources, databases, and the like for models, layers, and/or blocks that may have better accuracy, runtimes, and/or functionality that modules, blocks, and/or layers currently in the model.

In certain embodiments, the first portion 702 may include a section to enable the importation of modules into the application. For example, as shown in FIG. 7, a convolutional two-dimensional module, a Bottleneck module, a vision transformer module, and other modules may be imported or uploaded into the application and information identifying the imported modules may be displayed in first portion 702. In certain embodiments, the second portion 704 may serve as a digital canvas where the first user 101 may draw images and write text to describe an artificial intelligence model, such as in a freestyle fashion. In certain embodiments, for example, the first user 101 may draw a graph 708 including rectangles (or other shapes) as an indication for each module, layer, and/or block (e.g., 710) of an artificial intelligence model to be generated by the system 100. In certain embodiments, information identifying each module, layer, and/or block may be written as text within the rectangles (or other shapes) to identify the type of module, layer, and/or block. Additionally, the first user 101 may specify various properties of the module, layer, and/or block by writing or drawing in values corresponding to such properties. In certain embodiments, the first user 101 may specify the property and a value adjacent to it. For example, in the two-dimensional convolutional drawn rectangle in second portion 704, the first user 101 may write properties adjacent to the text “Conv2d” (which identifies a two-dimensional convolutional module) and then the value 3 to signify the kernel value (e.g., size or other kernel value), 64 for the maps value, 1 for the stride value, 1 for the padding value, and 1 for the dilation value. Notably, any other types of parameters may also be specified as well. In certain embodiments, the first user 101 may also draw the connections 712 between and/or among each module, layer, and/or block of the graph 708 of the model.

In certain embodiments, for the third portion 715, the neural network of the system 100 may analyze the drawn graph 708 in the second portion 704 and automatically generate a formal graph 718 corresponding to the drawn graph 708. Additionally, the neural network may identify modules for the formal graph 718 based on the text analyzed and extracted from the graph 708. In certain embodiments, the neural network may utilize vision transformers, convolutional neural networks, natural language processing, and other techniques to identify the modules 710 and the corresponding parameters specified to generate the formal modules 717 of the formal graph 718. Similarly, the neural network may detect the connections 712 and make formal versions of the connections for the formal graph 718. In certain embodiments, the fourth portion 720 may be a section of the user interface 700 that enables the first user 101 or even the neural network to select the properties of each module, block, and/or layer of the artificial intelligence model to be generated by the system 100. For example, as shown in FIG. 6, the properties may include, but are not limited to, the type of module, the kernel value, the stride value, the padding value, the dilation value, and maps values. In certain embodiments, once the properties are set, the system 100 may, such as when the first user 101 selects the “generate code” button on the interface 700, generate and display the code for each module of the artificial intelligence model. The system 100 may also provide a real-time indication of the total amount of parameters for the model and the total number of operations. In certain embodiments, as modules, layers, and/or blocks are changed in the graph 708, the formal graph 718, or both, the parameter values and operation values in fifth portion 725 may be updated in real-time and the code may be adjusted in real-time as well. Similarly, as the properties are adjusted, the parameters and operations may be adjusted in real time, and the code may be adjusted in real-time as well.

In certain embodiments, in fourth portion 720 there may also be a section to enable optimization of a generated artificial intelligence model. For example, in FIG. 7, the second “conv2d” block (i.e., containing a two-dimensional convolutional layer) may be selected and the system 100 may provide the option to either replace the block (and module(s)) with some predefined modules or run automatic optimization (e.g., via the radio button in fourth portion 720) using neural architecture search, which is described in detail further below in the present disclosure. Since, in this example, the automatic optimization may be selected, modules which can be manually selected may be deactivated. If the first user 101 initiates the start button, the system 100 may conduct a neural architecture search for substitute blocks, layers, and/or modules and may replace the selected conv2d block with a more efficient and/or more accurate block (or module). In certain embodiments, the first user 101 and/or the neural network may have the option of selecting how aggressive (e.g., reduce operations and/or parameters by a certain percentage or number) they want to be with the reduction of operations and parameters using an “Intensity” option. In certain embodiments, the system 100 may enable the first user 101 to select which blocks, layers, and/or modules to replace within the artificial intelligence model.

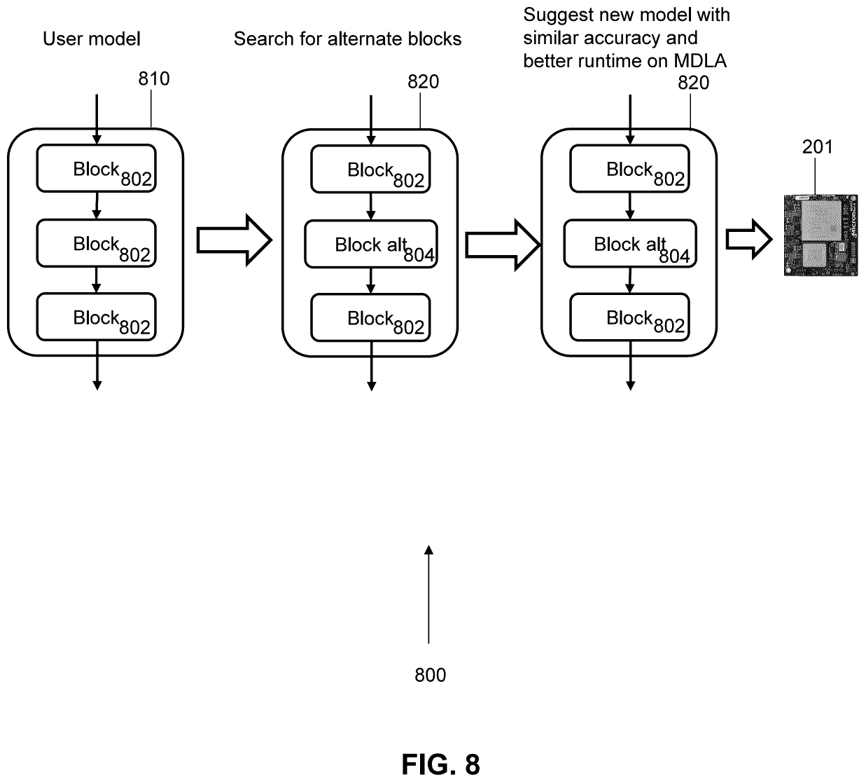

Referring now also to FIG. 8, an example illustrating intermediate neural architecture search according to embodiments of the present disclosure is schematically illustrated. FIG. 8, for example, illustrates an exemplary pre-trained user model 810 that may include any number of blocks 802 (or layers), which may each include any number of modules supporting the operative functionality of the module 810. Utilizing the operative functionality of the system 100, the system 100, such as by utilizing a neural network, may search for alternate blocks to substitute one or more of the blocks 802. For example, an alternate block 804 may be located via online repositories and/or a search space to replace the middle block 802 shown in FIG. 8. The processes of the present disclosure may be executed to determine accuracy ranks for the located blocks (or modules) and runtime ranks based on execution on a deep learning accelerator 203 of an integrated circuit 201. In certain embodiments, the pareto optima between the accuracy and runtime ranks may be selected and the module and/or block may be substituted in place of middle block 802 by using block 804 that includes a higher performing module, thereby resulting in an optimized model 820 for performing a particular task, such as a computer vision task.

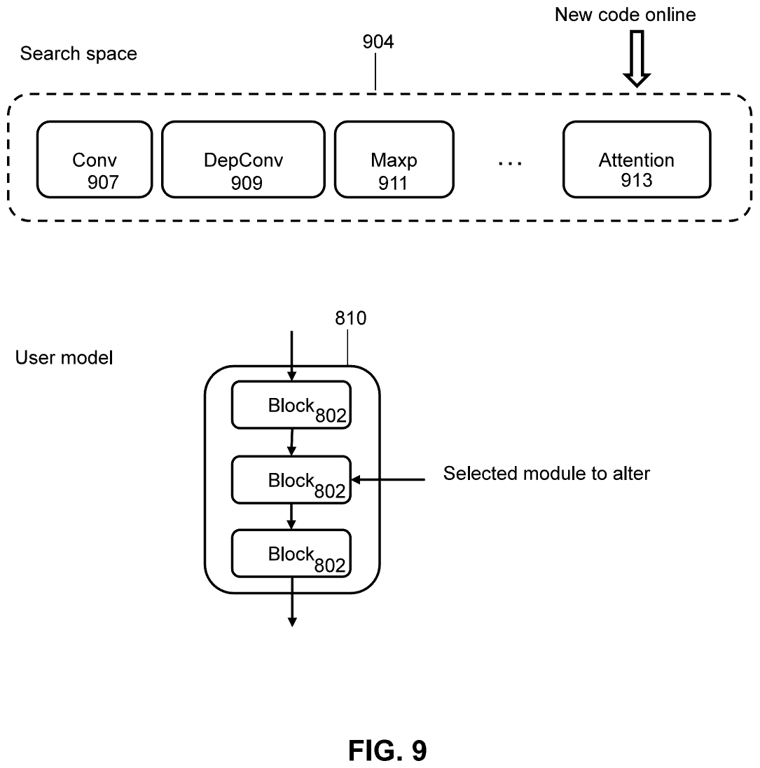

Referring now also to FIGS. 9, 10, 11, and 12, further details relating to the process of intermediate neural architecture search, such as to locate modules, blocks, and/or layers to substitute into an existing artificial intelligence mode, are schematically shown. The system 100 may search for new or updated modules and/or code from a plurality of repositories. Possible modules for substituting one or more modules in a user model 810 may be grouped into a module collection within a search space 904. For example, the modules may be a convolutional module 907, a depth separable module 909, a max pooling module 911, an attention module 913, any other modules, or a combination thereof. In certain embodiments, the system 100 may determine that the middle block 802 of user model 810 of FIG. 9 takes a disproportionate amount of computing resources when compared to the top and bottom blocks 802, and, as a result, would be a good candidate for substitution with a new or updated block containing a new or updated module. The system may set that block/layer as the choice block 804 for potential substitution and as the insertion point for the new module(s) and block.

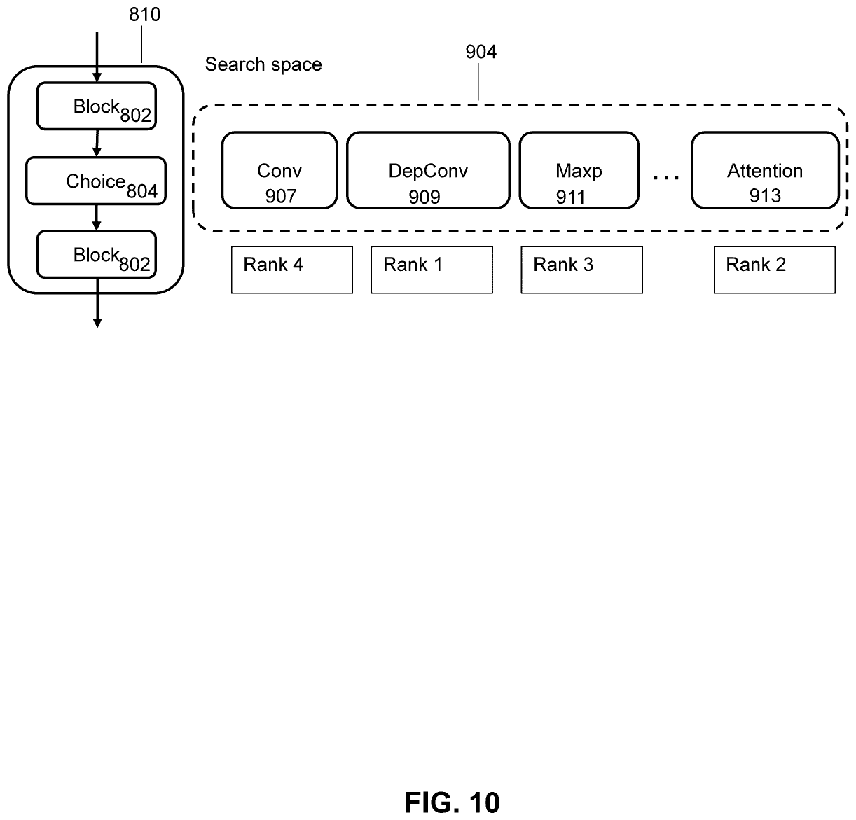

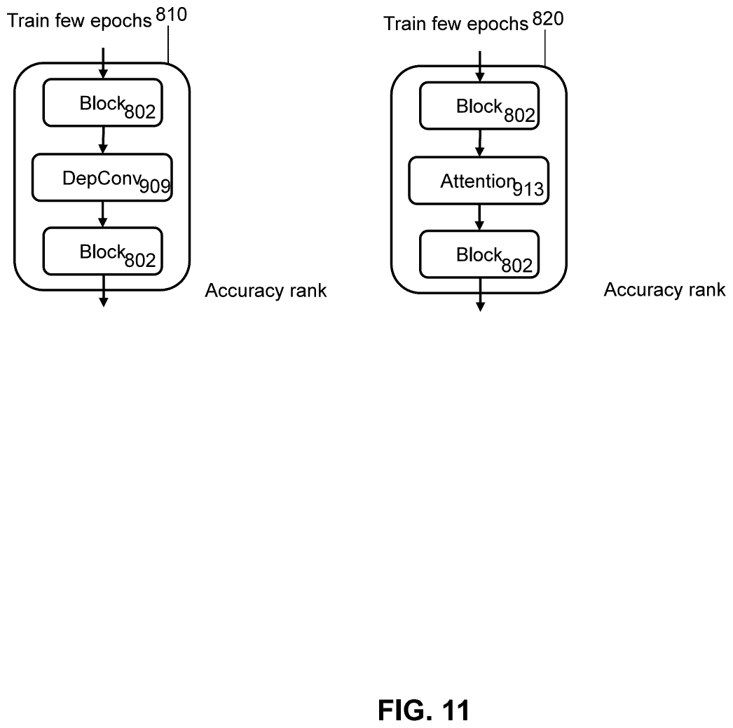

In certain embodiments, as shown in FIG. 10, a metric (e.g. zero-shot metric) may be applied to the modules in the collection to determine an initial ranking of the modules in the collection. For example, as shown in FIG. 10, the depth separate module 909 may be ranked 1, the attention module 913 may be ranked 2, the max pooling module 911 may be ranked 3, and the convolutional layer 907 may be ranked 4. Then, the system 100 may determine accuracy ranks for each of the preliminarily ranked modules by conducting intermediate module distillation, which may involve utilizing teacher modules to train student modules without having to train the entire model itself. The intermediate module distillation may be utilized to determine accuracy ranks for each of the modules. For example, system 100 may select the top k (e.g., in this case 2) modules for participating in the distillation. As shown in FIG. 11 and using the prior rankings, the attention module 913 may be substituted in the middle block 802 to make a model 820 and the depth separable module 909 may be substituted in the middle block 802 to make a model 810. The distillation may determine the accuracy rank based on which module trains faster and provides greater accuracy.

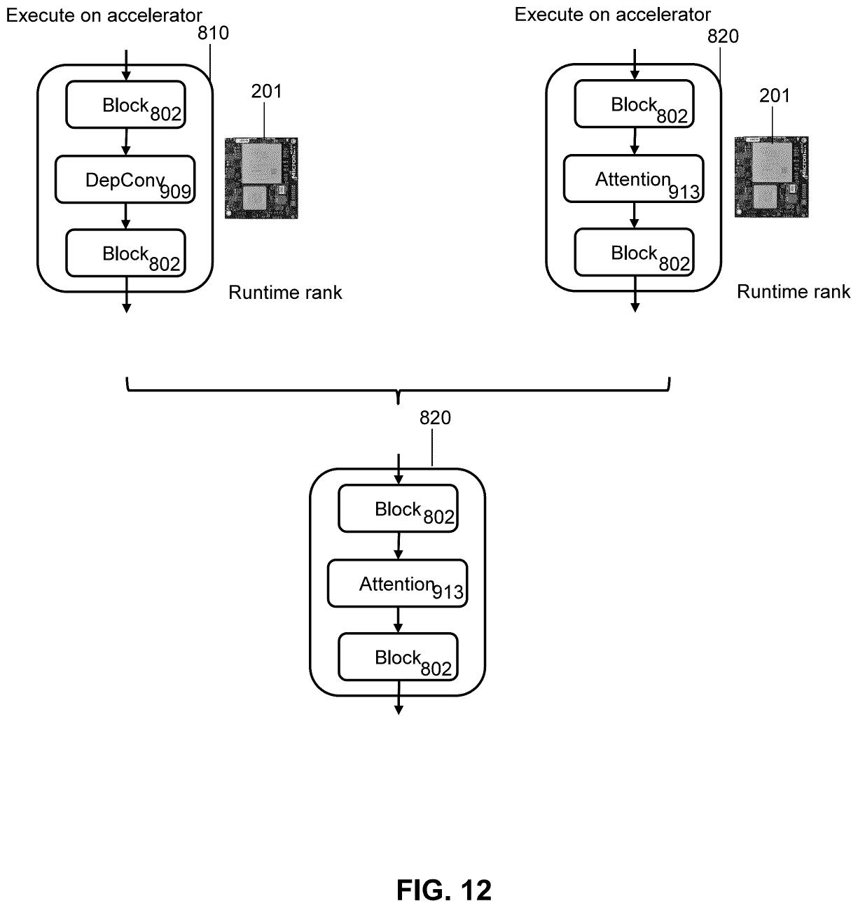

Then, as shown in FIG. 12, the system 100 may run the top-k candidate models (or modules) on the deep learning accelerator 203 of the integrated circuit 201 to determine the runtime execution for the candidate models (or modules). In certain embodiments, the pareto optima between the accuracy rank and the runtime rank may be the module selected for substitution. For example, in FIG. 12, the attention module 913 may be selected and substituted into the middle block 802/choice block 804 to create an optimal proposed model 820 that may be configured to perform an artificial intelligence task with at least the same or better accuracy as the original user model, while also having superior run time. The process may be repeated as desired as new and/or updated modules are available in the repositories.

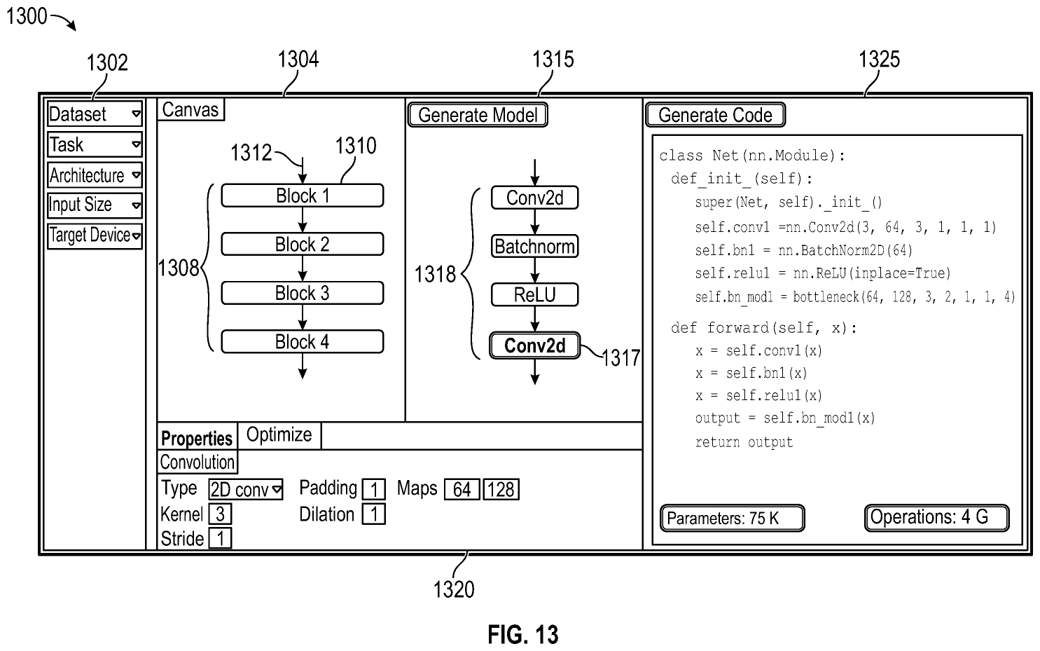

Referring now also to FIG. 13, an exemplary user interface 1300 enabling generation of an artificial intelligence model providing customization capabilities and utilizing intermediate neural architecture search is shown. In certain embodiments, the user interface 1300 may be rendered for display on the device being utilized by a user, such as on the first user device 102 of the first user 101. In certain embodiments, the user interface 1300 may include a first portion 1302, a second portion 1304, a third portion 1315, a fourth portion 1320, and a fifth portion 1325. In certain embodiments, the user interface 700 may provide access to similar functionality as the other user interfaces 500, 600, 700 however, the user interface 1300 may include further features and functionality. For example, the user interface 1300 may provide for a feature to activate neural architecture search functionality to automatically update one or more layers, blocks, and/or modules of a generated artificial intelligence model, such as by searching various repositories, resources, databases, and the like for models, layers, and/or blocks that may have better accuracy, runtimes, and/or functionality that modules, blocks, and/or layers currently in the model. Additionally, the user interface 1300 may provide for further customization and settings to facilitate development of the artificial intelligence model.

In certain embodiments, the first portion 1302 may include a section to enable the importation of modules into the application. In certain embodiments, the first portion 1302 may include options to specify various information associated with the artificial intelligence model and/or what the artificial intelligence model is to do. For example, the first portion 1302 may include a dataset option that may allow identification of a specific dataset that the artificial intelligence model is to train on or to analyze (e.g., a dataset of images for which image classification is supposed to be conducted by the model) using the artificial intelligence model, a task option that specify the type of task to be performed on the dataset, an architecture option to specify the architecture for the model (e.g., layer configuration, block configuration, model configuration, etc.), an input size option (e.g., specify how much data and/or the quantity of inputs for the artificial intelligence model, a target device option (e.g., to specify which device will execute the artificial intelligence model (e.g., a deep learning accelerator 203)), among any other options. Based on the selections of the options, the neural network of the system 100 may factor the selections when developing the artificial intelligence model. In certain embodiments, the second portion 1304 may serve as a digital canvas where the first user 101 may draw images and write text to describe an artificial intelligence model, such as in a freestyle fashion. In certain embodiments, for example, the first user 101 may draw a graph 1308 including rectangles (or other shapes) as an indication for each module, layer, and/or block (e.g., 1310) of an artificial intelligence model to be generated by the system 100. In certain embodiments, information identifying each module, layer, and/or block may be written as text within the rectangles (or other shapes) to identify the type of module, layer, and/or block. Additionally, the first user 101 may specify various properties of the module, layer, and/or block by writing or drawing in values corresponding to such properties. In certain embodiments, the first user 101 may specify the property and a value adjacent to it. For example, in the two-dimensional convolutional drawn rectangle in second portion 1304, the first user 101 may write properties adjacent to the text “Conv2d” (which identifies a two-dimensional convolutional module) and then the value 3 to signify the kernel value (e.g., size or other kernel value), 64 for the maps value, 1 for the stride value, 1 for the padding value, and 1 for the dilation value. Notably, any other types of parameters may also be specified as well. In certain embodiments, the first user 101 may also draw the connections 1312 between and/or among each module, layer, and/or block of the graph 1308 of the model.

In certain embodiments, for the third portion 1315 the neural network of the system 100 may analyze the drawn graph 1308 in the second portion 1304 and automatically generate a formal graph 1318 corresponding to the drawn graph 1308. Additionally, the neural network may identify modules for the formal graph 1318 based on the text analyzed and extracted from the graph 1308. In certain embodiments, the neural network may utilize vision transformers, convolutional neural networks, natural language processing, and other techniques to identify the modules 1310 and the corresponding parameters specified to generate the formal modules 1317 of the formal graph 1318. Similarly, the neural network may detect the connections 1312 and make formal versions of the connections for the formal graph 1318. In certain embodiments, the fourth portion 1320 may be a section of the user interface 1300 that enables the first user 101 or even the neural network to select the properties of each module, block, and/or layer of the artificial intelligence model to be generated by the system 100. For example, the properties may include, but are not limited to, the type of module, the kernel value, the stride value, the padding value, the dilation value, and maps values. In certain embodiments, once the properties are set, the system 100 may, such as when the first user 101 selects the “generate code” button on the interface 1300, generate and display the code for each module of the artificial intelligence model. The system 100 may also provide a real-time indication of the total amount of parameters for the model and the total number of operations. In certain embodiments, as modules, layers, and/or blocks are changed in the graph 1308, the formal graph 1318, or both, the parameter values and operation values in fifth portion 1325 may be updated in real-time and the code may be adjusted in real-time as well. Similarly, as the properties are adjusted, the parameters and operations may be adjusted in real time, and the code may be adjusted in real-time as well.

In certain embodiments, the first user 101 can just draw the number of blocks/layers they want in their model or provide a general guideline. After getting the information from the left column drop down menus in first section 1302, the tool will know the type of task it has to perform (e.g., categorization/detection/segmentation etc.), the architecture to look for (resnet/ViT/encoder-decoder, etc.), and the target device (datacenter/automotive/embedded device, etc.). Based on this information, the system 100 may populate the model skeleton with state-of-the-art modules searched from the web used for that task and suggest the new model to the user. If a paper or document is provided, the artificial intelligence model (e.g., huggingface-bert) may use text descriptions to guide the new model generation along with the modules database collected from the web.

Notably, as shown in FIG. 1, the system 100 may perform any of the operative functions disclosed herein by utilizing the processing capabilities of server 160, the storage capacity of the database 155, or any other component of the system 100 to perform the operative functions disclosed herein. The server 160 may include one or more processors 162 that may be configured to process any of the various functions of the system 100. The processors 162 may be software, hardware, or a combination of hardware and software. Additionally, the server 160 may also include a memory 161, which stores instructions that the processors 162 may execute to perform various operations of the system 100. For example, the server 160 may assist in processing loads handled by the various devices in the system 100, such as, but not limited to, receiving and/or analyzing manually-generated content as inputs for use in generating an artificial intelligence model (e.g., hand-drawn modules or models, digitally drawn modules or models, documents containing descriptions of models or modules, images containing visual information indicative of a model or module, etc.); extracting text associated with the manually generated content, detecting portion(s) of the inputs that are indicative of a visual representation of at least one module of the artificial intelligence model; receiving selections to set properties of the artificial intelligence modules and/or models; generating a graph of the artificial intelligence model based on the text and/or portion of the content; generating a model definition for the artificial intelligence model by generating code for the artificial intelligence model; executing the model definition of the artificial intelligence model to perform a task (e.g., a computer vision task, such as, but not limited to, image segmentation, image classification, image-based content retrieval, object detection, etc.), searching for modules in repositories that may serve as substitutes for modules of the artificial intelligence model, updating or modifying the model definition of the artificial intelligence model with higher accuracy and/or better runtime modules; and performing any other suitable operations conducted in the system 100 or otherwise. In certain embodiments, multiple servers 160 may be utilized to process the functions of the system 100. The server 160 and other devices in the system 100, may utilize the database 155 for storing data about the devices in the system 100 or any other information that is associated with the system 100. In one embodiment, multiple databases 155 may be utilized to store data in the system 100.

Although FIGS. 1-14 illustrates specific example configurations of the various components of the system 100, the system 100 may include any configuration of the components, which may include using a greater or lesser number of the components. For example, the system 100 is illustratively shown as including a first user device 102, a second user device 111, a communications network 135, a server 140, a server 145, a server 150, a server 160, and a database 155. However, the system 100 may include multiple first user devices 102, multiple second user devices 111, multiple communications networks 135, multiple servers 140, multiple servers 145, multiple servers 150, multiple servers 160, multiple databases 155, and/or any number of any of the other components inside or outside the system 100. Similarly, the system 100 may include any number of integrated circuits 201, deep learning accelerators 203, model workbenches 401, papers 406, online repositories 410, system profiles 416, search spaces, layers, blocks, modules, models, repositories, or a combination thereof. Furthermore, in certain embodiments, substantial portions of the functionality and operations of the system 100 may be performed by other networks and systems that may be connected to system 100.

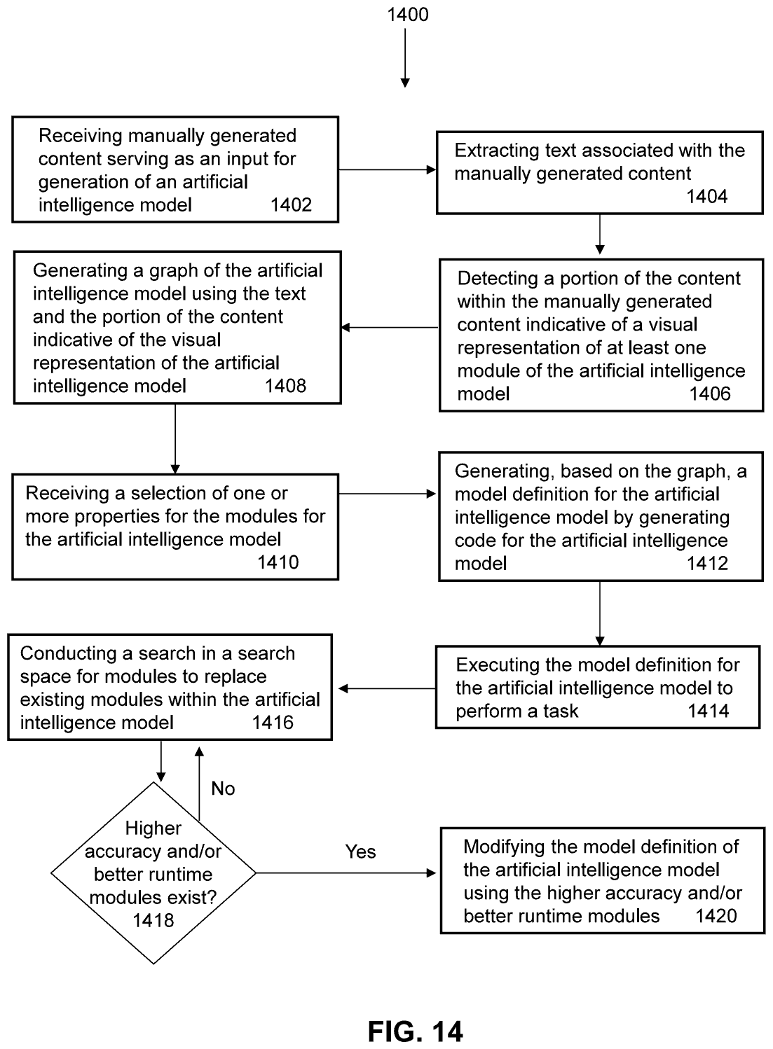

Referring now also to FIG. 14, FIG. 14 illustrates a method 1400 for providing neural network model definition code generation and optimization according to embodiments of the present disclosure. For example, the method of FIG. 14 can be implemented in the system of FIG. 1 and/or any of the other systems, devices, and/or componentry illustrated in the Figures. In certain embodiments, the method of FIG. 14 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method of FIG. 14 may be performed at least in part by one or more processing devices (e.g., processor 102, processor 112, processor 141, processor 146, processor 151, and processor 161 of FIG. 1). Although shown in a particular sequence or order, unless otherwise specified, the order of the steps in the method 1400 may be modified and/or changed depending on implementation and objectives. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 1400 may include steps for utilizing neural networks to automatically generate graphs for an artificial intelligence model and code for model definitions of the artificial intelligence model based on various inputs, such as, but not limited to, documents containing descriptions of modules, modules obtained or accessed from online repositories, freehand or manually drawn modules or models, and/or other inputs. The method 1400 may also include optimizing artificial intelligence models through a variety of techniques, such as by periodically scouring online repositories for more efficient and/or more accurate modules that may be substituted for one or more modules of an existing artificial intelligence model. In certain embodiments, the method 1400 may be performed by utilizing system 100, and/or by utilizing any combination of the componentry contained therein and any other systems and devices described herein. At step 1102, the method 1100 may include receiving manually-generated content that may serve as an input to facilitate generation of an artificial intelligence model. In certain embodiments, for example, the input may comprise a scanned handwritten sketch of a graph of an artificial intelligence model (e.g., nodes and edges of an artificial intelligence model using hand drawn blocks and lines), a digitally drawn sketch of the graph of the artificial intelligence model (e.g., such as by utilizing a drawing program (e.g., PowerPoint, Word, Photoshop, Visio, etc.)), any other type of manually-generated content, or a combination thereof. In certain embodiments, the manually-generated content may include drawn blocks (e.g., squares, rectangles, circles, ovals, ellipses, and/or other shapes), lines (e.g., to show connections between one or more blocks), text describing the blocks and/or connections, properties of the blocks and/or connections, any other information, or a combination thereof.

In certain embodiments, the manually-generated content may comprise audio content, video content, audiovisual content, augmented reality content, virtual reality content, haptic content, any type of content, or a combination thereof. In certain embodiments, the input may include documentation (e.g., white papers, articles, scientific journals, descriptions of modules, etc.), artificial intelligence modules, artificial intelligence models, or a combination thereof. In certain embodiments, the manually-generated content may be generated and uploaded into an application supporting the operative functionality of the system 100. In certain embodiments, the manually-generated content may be generated directly within the application supporting the operative functionality of the system 100. In certain embodiments, the manually-generated content may be transmitted from another application, devices, and/or system to the application supporting the functionality of the system 100. In certain embodiments, the receiving of the manually-generated content may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1404, the method 1400 may include extracting text associated with the manually-generated content. For example, if the manually-generated content is a manually-drawn sketch of a graph of an artificial intelligence model, the system 100 may utilize computer vision techniques (e.g., convolutional neural networks, vision transformers, etc.) and/or other artificial intelligence techniques to detect the text present in the sketch. In certain embodiments, the system 100 may utilize natural language processing techniques and modules to extract the text from the manually-generated content, meaning from the text, or a combination thereof. In certain embodiments, the extracting of the text associated with the manually-generated content may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device. At step 1406, the method 1400 may include detecting a portion of the content within the manually-generated content that is indicative of a visual representation of at least one module, layer, block, and/or other feature of an artificial intelligence model. For example, such as by utilizing a convolutional network and/or a vision transformer on a manually-generated image, the system 100 may detect the presence of the outline of a box, the text in and/or in a vicinity of the box (e.g., a description of what the box represents (e.g., convolutional layer or module, attention layer or module, etc.)), written properties of a module represented by the box, colors of the outline of the box, colors of the text within or in a vicinity of the box, any detectable information, or a combination thereof. In certain embodiments, the detecting of the portion of the content may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1408, the method 1400 may include generating a graph of the artificial intelligence model using the text, the portion of the content indicative of the visual representation, any other information extracted from the manually-generated content, or a combination thereof. For example, the system 100, such as by utilizing a neural network, may generate a graph representing an artificial intelligence model. The graph may include any number of modules, layers, blocks, connections (e.g., lines connecting blocks, modules, layers, etc.), or a combination thereof. Additionally, in certain embodiments, modules, layers, and/or blocks may represent nodes and the connections may be vertices of the graph. In certain embodiments, the system 100, such as by utilizing a neural network, may visually render the graph, such as on a user interface of an application supporting the operative functionality of the system 100. In certain embodiments, for example, the graph may be rendered so that a user, such as first user 101, may perceive the graph on the user interface of the application that may be executing and/or is accessible via the first user device 102. In certain embodiments, the generating of the graph may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1410, the method 1400 may include receiving a selection of one or more properties for the artificial intelligence model to be created by the system 100. In certain embodiments, the selection may be performed by the first user 101, such as by selecting an option to set a property via a user interface of the application supporting the operative functionality of the system 100. In certain embodiments, the first user 101 may directly input a value for a property into the application. In certain embodiments, properties may include, but are not limited to, a specification of a type of module for a particular layer of the artificial intelligence model (e.g., convolutional, attention, maxp, etc.), a kernel value (e.g., 3), a stride value, a padding value, a dilation value, a maps value, any type of property of a module, any type of property for a layer, any type of property for a model, or a combination thereof. In certain embodiments, the selection of the one or more properties may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1412, the method 1400 may include generating a model definition for the artificial intelligence model by generating code for the artificial intelligence model. In certain embodiments, the model definition may include the code for one or more of the modules contained within the artificial intelligence model. In certain embodiments, the model definition may identify the characteristics of the model, the specific modules of the model, the specific code to implement the modules of the model, the specific functionality of the model, the types of tasks that the model can perform, the computational resources required by the model, the parameters required for the module, the operations conducted by the model, any other features of a model, or a combination thereof. In certain embodiments, the model definition of the artificial intelligence model may be generated from the graph of the artificial intelligence model. For example, the graph may be utilized to identify the specific modules and connections between or among modules that the artificial intelligence model is to have. In certain embodiments, the model definition may be generated by a neural network and may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1414, the method 1400 may include executing the model definition for the artificial intelligence model to perform a task. For example, the system 100 may execute the model definition supporting the functionality of the artificial intelligence model to execute a task, such as a computer vision task (e.g., image classification, object detection, content-based image retrieval, image segmentation, etc.). In certain embodiments, the executing of the model definition may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device. At step 1416, the method 1400 may include conducting a search in a search space for modules to replace one or more existing modules within the artificial intelligence model. In certain embodiments, the system 100 may search for modules and/or models that are in any number of repositories. For example, the repositories may be online repositories that users and/or systems regularly upload modules to. In certain embodiments, the modules may be located on websites, databases, computer systems, computing devices, mobile devices, programs, files, any location connected to internet services, or a combination thereof. For example, the neural network may search for modules that may be utilized for CNNs, ViTs, deep learning models, and/or other artificial intelligence models to conduct tasks, such as, but not limited to computer vision or other tasks. As an example, computer vision tasks may include, but are not limited to, image classification (e.g., extracting features from image content and classifying and/or predicting the class of the image), object detection (e.g., identifying a certain class of image and then detect the presence of the image within image content), object tracking (e.g., tracking an object within an environment or media content once the object is detected), and content-based image retrieval (e.g., searching databases for content having similarity and/or correlation to content processed by the neural network), among other computer vision tasks.

In certain embodiments, the system 100 may select any number of modules for inclusion in the search space. The system 100 may select the modules randomly, based on characteristics of the modules, based on the types of tasks that the modules are capable of performing, the runtime of the modules (e.g., on a deep learning accelerator 203), the accuracy of the modules, the amount of resources that the modules utilize, the amount of code in the modules, the type of code in the modules, a similarity of the module to an existing module in an artificial intelligence model, a factor, or a combination thereof. In certain embodiments, the searching may be for modules that are capable of performing the same tasks as an existing module but have at least the same or similar accuracy as the existing module, while having superior runtimes. In certain embodiments, the algorithms supporting the functionality of the system 100 may locate modules from repositories based on the relevance and/or characteristics of the module to performing a particular task. For example, if the task is a computer vision task, the system 100 may locate modules that may be utilized to optimize image detection or image classification, for example. The system 100 may analyze the characteristics, features, data structures, code, and/or other aspects of a module and compare them to the characteristics of a task to determine the relevance and/or matching of the module for the task. In certain embodiments, the modules may be located and/or identified based on the ability for the module to contribute to accuracy of a task and/or based on the impact that the functionality of the module has on execution runtime of the module and/or model within which the module would reside. Additionally, the search space and the repositories may be dynamic in that modules may be added, updated, modified, and/or removed from the search space and/or repositories on a regular basis. The search space and/or the repositories may be searched continuously, at periodic intervals, at random times, or at specific times. In certain embodiments, the searching for the plurality of modules may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

In certain embodiments, the method 1400 may include, at step 1416 or at any other desired time, determining, such as by utilizing the neural network, an insertion point within an existing artificial intelligence model to replace with a module from the search space. For example, the insertion point may correspond with a layer, module, block, or other component of the existing artificial intelligence model that may be a candidate for optimization with a replacement or substitute layer, module, block, or other component that may enable the model as a whole to perform more efficiently and/or accurately during performance of a task. In certain embodiments, a layer, block, module, or other component may be a candidate for substitution or replacement if the current layer, block module, or other component has a threshold level of impact on execution runtime of the model when performing a tasks, uses a threshold amount of computing resources, contributes to accuracy of performance of the tasks, is identified as critical for performance of the task, is identified as not being optimized, is identified as having possible replacements, is identified as taking a threshold amount of time to perform tasks, has a threshold amount of workload during performance of a tasks, has a greater number of activations than other layers, modules, blocks, and/or components of the model, or a combination thereof.

In certain embodiments, artificial intelligence algorithms supporting the functionality of the neural network may be utilized to select not only insertion points, but also connections (e.g. connections to modules within a model, connections to programs, any type of connections, or a combination thereof). In certain embodiments, the artificial intelligence algorithms may seek to only select certain layers, modules, blocks, or other components for substitution rather than the entire model. A model, for example, may include any number of modules, which together may be configured to perform the operative functionality of the model. The algorithms may do so to preserve as many characteristics and features of the original model as possible, while also enhancing the performance of the model by substituting portions of model instead of the entire model. In certain embodiments, the determining may be performed and/or facilitated by utilizing the first user device 102, the second user device 111, the server 140, the server 145, the server 150, the server 160, the communications network 135, any component of the system 100, any combination thereof, or by utilizing any other appropriate program, network, system, or device.

At step 1418, the method 1400 may include determining whether higher accuracy (or at least the same or similar accuracy as an existing module) modules are present in the search space, whether there are modules that are capable of performing the same tasks that have better runtimes than an existing module, whether there are modules in the search space that have greater capabilities to perform a greater number of tasks than an existing module, whether there are modules that have any type of improvement over an existing module, whether there are modules that may be combined with existing modules to enhance performance, or a combination thereof. If there are no higher (or at least similar) accuracy modules, better runtime modules, or other modules for substitution in the search space, the method 1400 may continue the search at step 1416. If, however, there are higher (or at least similar) accuracy modules, better runtime modules, or other modules for substitution in the search space, the method 1400 may proceed to step 1420. At step 1420, the method 1400 may include modifying the model definition of the artificial intelligence model to replace one or more existing modules of the artificial intelligence model with a substitute model(s) that may perform more accurately, have better runtime, have superior features, or a combination thereof. In certain embodiments, the method 1400 may be repeated as desired and/or by the system 100. Notably, the method 1400 may incorporate any of the other functionality as described herein and may be adapted to support the functionality of the system 100.

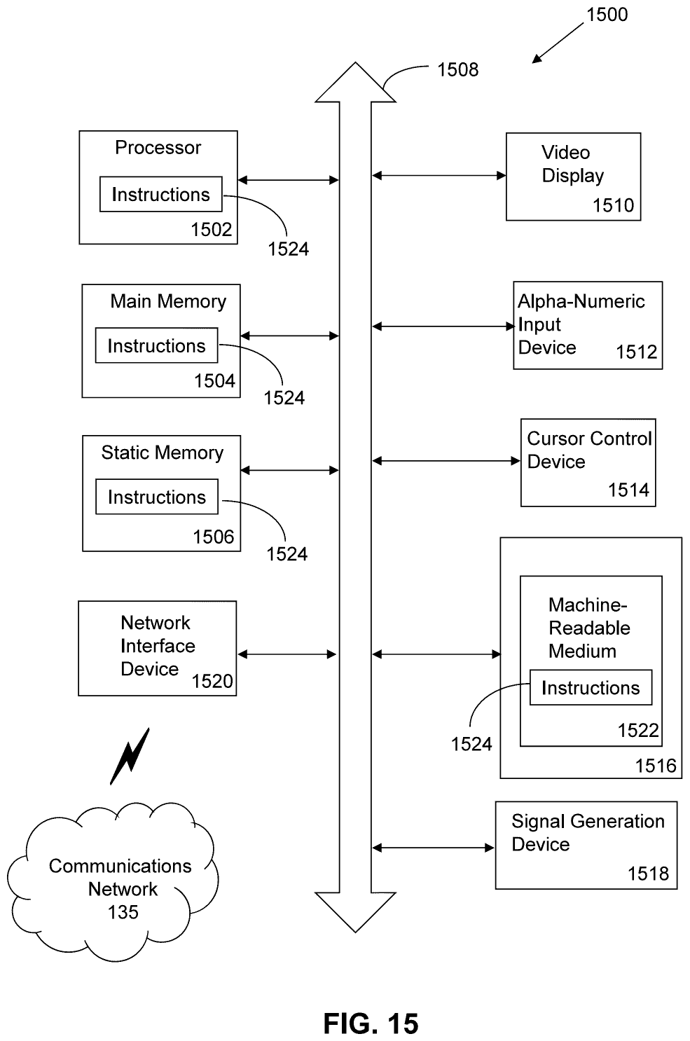

Referring now also to FIG. 15, at least a portion of the methodologies and techniques described with respect to the exemplary embodiments of the system 100 and/or method 1400 can incorporate a machine, such as, but not limited to, computer system 1500, or other computing device within which a set of instructions, when executed, may cause the machine to perform any one or more of the methodologies or functions discussed above. The machine may be configured to facilitate various operations conducted by the system 100. For example, the machine may be configured to, but is not limited to, assist the system 100 by providing processing power to assist with processing loads experienced in the system 100, by providing storage capacity for storing instructions or data traversing the system 100, or by assisting with any other operations conducted by or within the system 100. As another example, in certain embodiments, the computer system 1500 may assist in receiving and/or analyzing manually-generated content as inputs for use in generating an artificial intelligence model, extracting text associated with the manually generated content, detecting portion(s) of the inputs that are indicative of a visual representation of at least one module of the artificial intelligence model, generating a graph of the artificial intelligence model based on the text and/or portion of the content, receiving selections for properties of the modules for the artificial intelligence model, generating a model definition for the artificial intelligence model by generating code for the artificial intelligence model, executing the model definition of the artificial intelligence model to perform a task (e.g., a computer vision task, such as, but not limited to, image segmentation, image classification, image-based content retrieval, object detection, etc.), searching for modules in repositories that may serve as substitutes for modules of the artificial intelligence model, modifying the model definition of the artificial intelligence model with higher accuracy and/or better runtime modules, and/or performing any other operations of the system 100.

In some embodiments, the machine may operate as a standalone device. In some embodiments, the machine may be connected (e.g., using communications network 135, another network, or a combination thereof) to and assist with operations performed by other machines and systems, such as, but not limited to, the first user device 102, the second user device 111, the server 140, the server 145, the server 150, the database 155, the server 160, any other system, program, and/or device, or any combination thereof. The machine may be connected with any component in the system 100. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The computer system 1500 may include a processor 1502 (e.g., a central processing unit (CPU), a graphics processing unit (GPU, or both), a main memory 1504 and a static memory 1506, which communicate with each other via a bus 1508. The computer system 1500 may further include a video display unit 1510, which may be, but is not limited to, a liquid crystal display (LCD), a flat panel, a solid-state display, or a cathode ray tube (CRT). The computer system 1500 may include an input device 1512, such as, but not limited to, a keyboard, a cursor control device 1514, such as, but not limited to, a mouse, a disk drive unit 1516, a signal generation device 1518, such as, but not limited to, a speaker or remote control, and a network interface device 1520.

The disk drive unit 1516 may include a machine-readable medium 1522 on which is stored one or more sets of instructions 1524, such as, but not limited to, software embodying any one or more of the methodologies or functions described herein, including those methods illustrated above. The instructions 1524 may also reside, completely or at least partially, within the main memory 1504, the static memory 1506, or within the processor 1502, or a combination thereof, during execution thereof by the computer system 1500. The main memory 1504 and the processor 1502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine-readable medium 1522 containing instructions 1524 so that a device connected to the communications network 135, another network, or a combination thereof, can send or receive voice, video or data, and communicate over the communications network 135, another network, or a combination thereof, using the instructions. The instructions 1524 may further be transmitted or received over the communications network 135, another network, or a combination thereof, via the network interface device 1520.

While the machine-readable medium 1522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that causes the machine to perform any one or more of the methodologies of the present disclosure.

The terms “machine-readable medium,” “machine-readable device,” or “computer-readable device” shall accordingly be taken to include, but not be limited to: memory devices, solid-state memories such as a memory card or other package that houses one or more read-only (non-volatile) memories, random access memories, or other re-writable (volatile) memories; magneto-optical or optical medium such as a disk or tape; or other self-contained information archive or set of archives is considered a distribution medium equivalent to a tangible storage medium. The “machine-readable medium,” “machine-readable device,” or “computer-readable device” may be non-transitory, and, in certain embodiments, may not include a wave or signal per se. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description. Therefore, it is intended that the disclosure is not limited to the particular arrangement(s) disclosed as the best mode contemplated for carrying out this invention, but that the invention will include all embodiments and arrangements falling within the scope of the appended claims.

The foregoing is provided for purposes of illustrating, explaining, and describing embodiments of this invention. Modifications and adaptations to these embodiments will be apparent to those skilled in the art and may be made without departing from the scope or spirit of this invention. Upon reviewing the aforementioned embodiments, it would be evident to an artisan with ordinary skill in the art that said embodiments can be modified, reduced, or enhanced without departing from the scope and spirit of the claims described below.

What is claimed is:

1. A system, comprising:
a memory; and
a processor, wherein the processor is configured to;
facilitate, by utilizing a neural network, selection of a plurality of modules for inclusion in an artificial intelligence model;
facilitate, by utilizing the neural network, selection of a property for each module of the plurality of modules for the artificial intelligence model;
establish, by utilizing the neural network, a connection between each module selected from the plurality of modules with at least one other module selected from the plurality of modules;
generate, by utilizing a neural network and based on the selection of the property for each module and the connection, a model definition for the artificial intelligence model by generating code for each module selected from the plurality of modules; and
execute a task by utilizing the artificial intelligence model via the model definition generated via the code for each module selected from the plurality of modules.

2. The system of claim 1, wherein the processor is further configured to update a parameter for at least one module of the plurality of modules of the artificial intelligence module after adding an additional module to or removing a module from the artificial intelligence model.

3. The system of claim 1, wherein the processor is further configured to update an operation for at least one module of the plurality of modules of the artificial intelligence model after adding an additional module to or removing a module from the artificial intelligence model.

4. The system of claim 1, wherein the processor is further configured to visually render a graph for the artificial intelligence model including a visual representation of each module of the plurality of modules selected for inclusion in the artificial intelligence model.

5. The system of claim 1, wherein the plurality of modules are pre-defined modules, custom-generated modules, or a combination thereof.

6. The system of claim 1, wherein the processor is further configured to identify at least one module of the plurality of modules of the artificial intelligence model for replacement.

7. The system of claim 6, wherein the processor is further configured to conduct a neural architecture search in a plurality of repositories to identify at least one replacement module to replace the at least one module for replacement.

8. The system of claim 1, wherein the processor is further configured to automatically modify the artificial intelligence model based on a change in the task.

9. The system of claim 1, wherein the processor is further configured to receive a manually drawn artificial intelligence model comprising manually drawn modules.

10. The system of claim 9, wherein the processor is further configured to extract text from each block in the manually drawn artificial intelligence model, and wherein the processor is further configured to identify at least one module from the plurality of modules correlating with the text.

11. The system of claim 10, wherein the processor is further configured to generate a different model definition corresponding to the manually drawn artificial intelligence model and including the at least one module from the plurality of modules correlating with the text.

12. The system of claim 1, wherein the processor is further configured to import the plurality of modules from a search space including a module collection.

13. A method, comprising:
receiving, by utilizing a neural network, manually generated content serving as an input for generation of an artificial intelligence model;
extracting, by utilizing the neural network, text associated with the manually generated content;
detecting, by utilizing the neural network, a portion of the content within the manually generated content indicative of a visual representation of at least one module of the artificial intelligence model;
generating, by utilizing the neural network, a graph of the artificial intelligence model using the text and the portion of the content indicative of the visual representation of the artificial intelligence model; and
generating, by utilizing the neural network and based on the graph of the artificial intelligence model, a model definition for the artificial intelligence model by generating code for the artificial intelligence model; and
executing, by utilizing the neural network, the model definition for the artificial intelligence model to perform a task.

14. The method of claim 13, further comprising generating the model definition for the artificial intelligence model by obtaining, via a neural architecture search, candidate modules for the artificial intelligence module from a repository.

15. The method of claim 13, further comprising enabling selection of at least one property of the artificial intelligence model via an interface of an application associated with the neural network.

16. The method of claim 13, further comprising displaying the code generated for the artificial intelligence model via a user interface.

17. The method of claim 13, further comprising enabling selection of the at least one module of the artificial intelligence model for replacement by at least one other module.

18. The method of claim 13, further comprising providing an option to adjust an intensity level for reducing operations or parameters associated with the artificial intelligence model.

19. The method of claim 13, further comprising providing a digital canvas to enable drawing of blocks, connections, modules, or a combination thereof, associated with the artificial intelligence model.

20. A device, comprising:
a memory; and
a processor;
wherein the processor is configured to identify, by utilizing a neural network, a task to be completed by an artificial intelligence model;
wherein the processor is configured to search, by utilizing the neural network, for a plurality of modules and content in a plurality of repositories;
wherein the processor is configured to extract, by utilizing the neural network, a portion of the content from the content that is associated with the task, the artificial intelligence model, or a combination thereof;
wherein the processor is configured to select, by utilizing the neural network, a set of candidate modules of the plurality of modules in the plurality of repositories based on a matching characteristics of the set of candidate modules with the task;
wherein the processor is configured to generate the artificial intelligence model based on the portion of the content and the set of candidate modules; and
wherein the processor is configured to execute the task using the artificial intelligence model.
